(19) United States
(12) Patent Application Publication
(10) Pub. No.: US 2026/0343383 A1
(43) Pub. Date: Oct. 29, 2026

(54) METHODS TO ADVERTISE DESIRED ENHANCED DATA PRIVACY (EDP) EPOCH GROUP'S PARAMETERS PRIOR TO STATION (STA) ASSOCIATION

(71) Applicant: InterDigital Patent Holdings, Inc., Wilmington, DE (US)

(72) Inventors: Antonio de la Oliva, Madrid (ES); Joseph Levy, Merrick, NY (US); Robert Gazda, Spring City, PA (US); Rui Yang, Melville, NY (US)

(73) Assignee: InterDigital Patent Holdings, Inc., Wilmington, DE (US)

(21) Appl. No.: 19/193,675

(22) Filed: Apr. 29, 2025

(51) Int. Cl. H04W 48/08; H04W 48/16; H04W 76/15

(52) U.S. Cl. CPC H04W 48/08; H04W 48/16; H04W 76/15

(57) ABSTRACT

A station (STA) may comprise a processor configured to receive a neighbor report element from an access point (AP). The reduced neighbor report may include information on group enhanced data privacy (EDP) epochs available in the AP. The information on the group EDP epochs available in the AP may include an epoch interval information, wherein the neighbor report element is configured to enable the STA to select the AP as a target AP from a plurality of APs based on the information on the available group EDP epochs. The processor may be configured to transmit, to the AP, an association request frame and/or a re-association request frame. The association request frame and/or the re-association request frame may include a desired EDP epoch group available in the AP based on the information on the available group EDP epochs.

### BACKGROUND

IEEE 802.11 has seen a trend towards providing mechanisms for the protection of the privacy of individuals using WLAN technology. One of the main areas of work in this aspect has been protecting users from those who track them. This means protecting the possible identification of users as they roam to different locations and IEEE 802.11 networks.

### SUMMARY

A station (STA) may comprise a processor. The processor may be configured to receive a neighbor report element from an access point (AP). The processor may be configured to receive a reduced neighbor report element from an AP. The neighbor report element and/or reduced neighbor report element may include, for example, information on group enhanced data privacy (EDP) epochs available in the AP. The information on the group EDP epochs available in the AP may include, for example, information associated with a default group EDP epoch or on other group EDP epochs in use by the AP. The information on the group EDP epochs available in the AP may include, for example, an epoch interval information, wherein neighbor report element and/or reduced neighbor report element is configured to enable the STA to select the AP as a target AP from a plurality of APs based on the information on the available group EDP epochs. The processor may be configured to transmit, to the AP, an association request frame and/or a re-association request frame. The association request frame or the re-association request frame may include, for example, a desired EDP epoch group available in the AP based on the information on the available group EDP epochs. The neighbor report element and/or the reduced neighbor report element may report on information of a different AP. For example, the EDP groups reported may not be the ones of the AP sending the element, but of a neighbor. In some examples, the EDP groups available are not in the AP sending the neighbor report element and/or the reduced neighbor report element but in the one reported in the neighbor report element and/or the reduced neighbor report element. In some examples, the selection of a target AP may be done considering the parameters of the EDP groups available in the target APs.

The information on the available group EDP epochs may include, for example, a group EDP epoch ID associated with each group EDP epoch available in the AP. The information on the available group EDP epochs may include, for example, a group EDP settings associated with each group EDP epoch available in the AP. EDP settings may include, for example, all the contents of the EDP epoch settings field.

The neighbor report element and/or the reduced neighbor report element may include, for example, a neighbor AP information field. The neighbor AP information field may include, for example, a target beacon transmission time (TBTT) information header field and a TBTT information set field. The reduced neighbor report may be configured to enable the STA to select the AP as a target AP from a plurality of APs based on the TBTT information. The association request frame and/or the re-association request frame may include, for example, a desired EDP epoch group available in the AP based on the TBTT information. The selection of the AP to which the encrypted (re) association request frame is sent may be decided based on the EDP epoch characteristics provided in the neighbor report element and/or the reduced neighbor report element.

The TBTT information header field may include, for example, at least one of TBTT information field type, filtered neighbor AP, TBTT information count and/or TBTT information length. The TBTT information set field may include, for example, one or more TBTT information fields.

Upon a condition that the value of the TBTT information field type is 0, the TBTT information field may include, for example, an EDP parameters field, neighbor AP TBTT offset, basic service set identifier (BSSID), short service set identifier (SSID), BSS parameters, 20 MHz power spectral density (PSD), and/or multi-link device (MLD) parameters. Upon a condition that the value of the TBTT information field type is 1, the TBTT information field format may include, for example, an EDP parameters field and multi-link device (MLD) parameters. The EDP parameters field may include, for example, a value of 0 or 5 octets.

Upon a condition that the value of the TBTT information field type is 0, the TBTT information field may include, for example, a reduced EDP parameter field, neighbor AP TBTT offset, basic service set identifier (BSSID), short service set identifier (SSID), BSS parameters, 20 MHz power spectral density (PSD), and/or multi-link device (MLD) parameters. Upon a condition that the value of the TBTT information field type is 1, the TBTT information field format may include, for example, a reduced EDP parameter field and multi-link device (MLD) parameters. The reduced EDP parameter field may include a value of 0 or 3 octets. The reduced EDP parameter field may include a group ID field and an epoch interval field. The group ID field may include, for example, a value and/or length of 1. The epoch interval field may include, for example, a value and/or length of 2.

Upon a condition that the value of the TBTT information field type is 0, the TBTT information field may include, for example, an epoch interval subfield, neighbor AP TBTT offset, basic service set identifier (BSSID), short service set identifier (SSID), BSS parameters, 20 MHz power spectral density (PSD), and/or multi-link device (MLD) parameters. Upon a condition that the value of the TBTT information field type is 1, the TBTT information field format may include, for example, an epoch interval subfield and multi-link device (MLD) parameters. The epoch interval subfield may include, for example, a value of 0 or 2 octets.

A STA may be configured to perform a method that includes one or more of the following steps. The method may include receiving a neighbor report element from an access point (AP). The method may include receiving a reduced neighbor report element from an AP. The neighbor report element and/or reduced neighbor report element may include, for example, information on group enhanced data privacy (EDP) epochs available in the AP. The information on the group EDP epochs available in the AP may include, for example, information associated with a default group EDP epoch or on other group EDP epochs in use by the AP. The information on the group EDP epochs available in the AP may include, for example, an epoch interval information, wherein neighbor report element and/or reduced neighbor report element is configured to enable the STA to select the AP as a target AP from a plurality of APs based on the information on the available group EDP epochs. The method may include transmitting, to the AP, an association request frame and/or a re-association request frame. The association request frame or the re-association request frame may include, for example, a desired EDP epoch group available in the AP based on the information on the available group EDP epochs. The neighbor report element and/or the reduced neighbor report element may report on information of a different AP. For example, the EDP groups reported may not be the ones of the AP sending the element, but of a neighbor. In some examples, the EDP groups available are not in the AP sending the neighbor report element and/or the reduced neighbor report element but in the one reported in the neighbor report element and/or the reduced neighbor report element. In some examples, the selection of a target AP may be done considering the parameters of the EDP groups available in the target APs.

The information on the available group EDP epochs may include, for example, a group EDP epoch ID associated with each group EDP epoch available in the AP. The information on the available group EDP epochs may include, for example, a group EDP settings associated with each group EDP epoch available in the AP. EDP settings may include, for example, all the contents of the EDP epoch settings field.

The neighbor report element and/or the reduced neighbor report element may include, for example, a neighbor AP information field. The neighbor AP information field may include, for example, a target beacon transmission time (TBTT) information header field and a TBTT information set field. The reduced neighbor report may be configured to enable the STA to select the AP as a target AP from a plurality of APs based on the TBTT information. The association request frame and/or the re-association request frame may include, for example, a desired EDP epoch group available in the AP based on the TBTT information. The selection of the AP to which the encrypted (re) association request frame is sent may be decided based on the EDP epoch characteristics provided in the neighbor report element and/or the reduced neighbor report element.

The TBTT information header field may include, for example, at least one of TBTT information field type, filtered neighbor AP, TBTT information count and/or TBTT information length. The TBTT information set field may include, for example, one or more TBTT information fields.

Upon a condition that the value of the TBTT information field type is 0, the TBTT information field may include, for example, an EDP parameters field, neighbor AP TBTT offset, basic service set identifier (BSSID), short service set identifier (SSID), BSS parameters, 20 MHz power spectral density (PSD), and/or multi-link device (MLD) parameters. Upon a condition that the value of the TBTT information field type is 1, the TBTT information field format may include, for example, an EDP parameters field and multi-link device (MLD) parameters. The EDP parameters field may include, for example, a value of 0 or 5 octets.

Upon a condition that the value of the TBTT information field type is 0, the TBTT information field may include, for example, a reduced EDP parameter field, neighbor AP TBTT offset, basic service set identifier (BSSID), short service set identifier (SSID), BSS parameters, 20 MHz power spectral density (PSD), and/or multi-link device (MLD) parameters. Upon a condition that the value of the TBTT information field type is 1, the TBTT information field format may include, for example, a reduced EDP parameter field and multi-link device (MLD) parameters. The reduced EDP parameter field may include a value of 0 or 3 octets. The reduced EDP parameter field may include a group ID field and an epoch interval field. The group ID field may include, for example, a value and/or length of 1. The epoch interval field may include, for example, a value and/or length of 2.

Upon a condition that the value of the TBTT information field type is 0, the TBTT information field may include, for example, an epoch interval subfield, neighbor AP TBTT offset, basic service set identifier (BSSID), short service set identifier (SSID), BSS parameters, 20 MHz power spectral density (PSD), and/or multi-link device (MLD) parameters. Upon a condition that the value of the TBTT information field type is 1, the TBTT information field format may include, for example, an epoch interval subfield and multi-link device (MLD) parameters. The epoch interval subfield may include, for example, a value of 0 or 2 octets.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A is an illustration of an example encrypted association procedure according to an embodiment.

FIG. 2B is an illustration of an example association process according to an embodiment.

FIG. 3 is an illustration of an example EDP Epoch Settings field format according to an embodiment.

FIG. 4 is an illustration of an example EDP List element according to an embodiment.

FIG. 5 is an illustration of an example Neighbor Report element format according to an embodiment.

FIG. 6 is an illustration of an example BSSID Information field format according to an embodiment.

FIG. 7 is an illustration of an example Neighbor AP Information field format according to an embodiment.

FIG. 8 is an illustration of an example TBTT Information Header subfield format according to an embodiment.

FIG. 9 is an illustration of an example TBTT Information field format if the TBTT Information Field Type subfield is equal to 0 according to an embodiment.

FIG. 10 is an illustration of an example TBTT Information field format when the TBTT Information Field Type sub-field is equal to 1 according to an embodiment.

FIG. 11 is an illustration of an example Neighbor AP Information field format according to an embodiment.

FIG. 12 is an illustration of an example TBTT Information Header subfield format according to an embodiment.

FIG. 13 is an illustration of an example TBTT Information field format if the TBTT Information Field Type subfield is equal to 0 format according to an embodiment.

FIG. 14 is an illustration of an example TBTT Information field format when the TBTT Information Field Type sub-field is equal to 1 according to an embodiment.

FIG. 15 is an illustration of an example Reduced EDP Parameter field according to an embodiment.

FIG. 16 is an illustration of an example Neighbor AP Information field format according to an embodiment.

FIG. 17 is an illustration of an example Neighbor AP Information field format according to an embodiment.

FIG. 18 is an illustration of an example TBTT Information field format if the TBTT Information Field Type subfield is equal to 0 according to an embodiment.

FIG. 19 is an illustration of an example TBTT Information field format when the TBTT Information Field Type sub-field is equal to 1 according to an embodiment.

### DETAILED DESCRIPTION

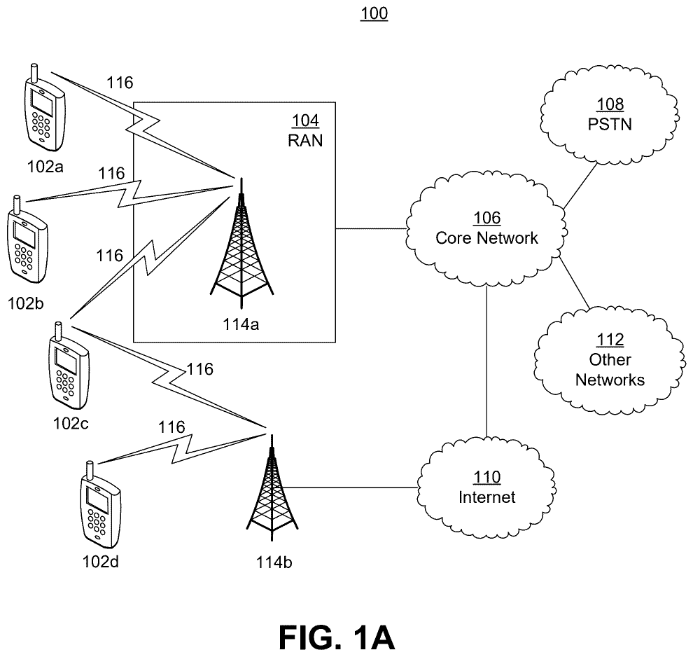

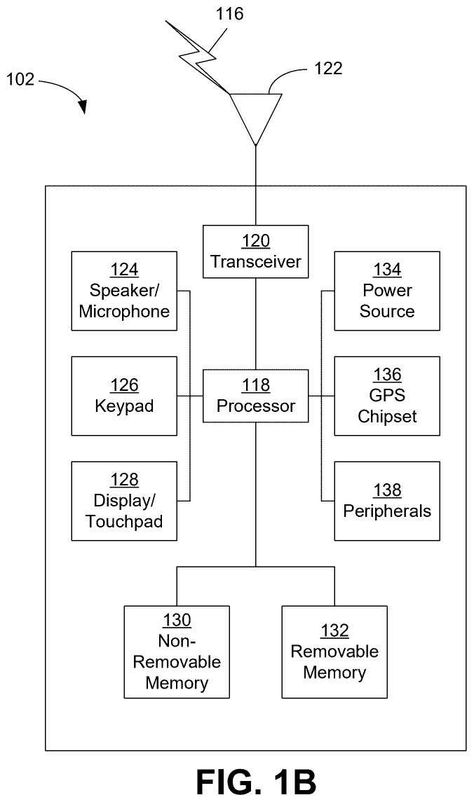

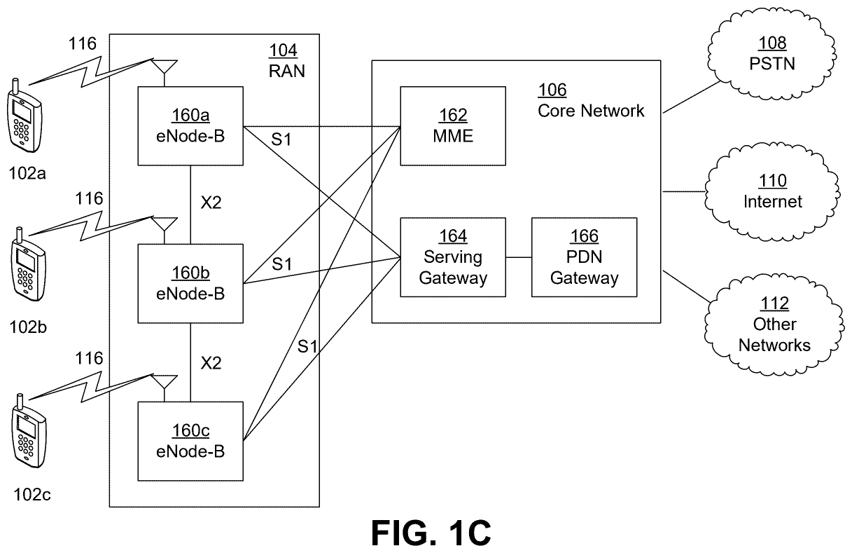

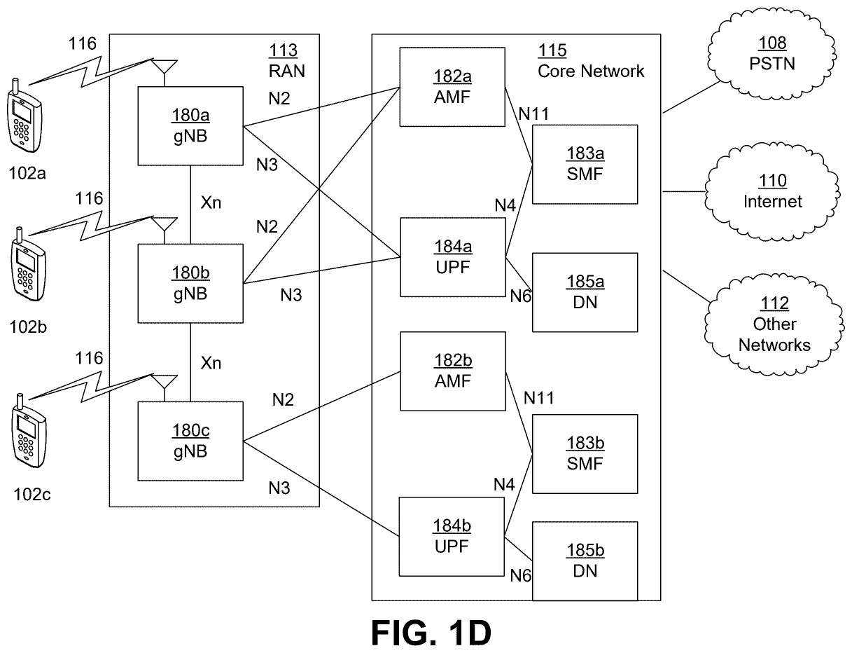

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment.

The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11 ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11 ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11 ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability—UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

A “UE,” “STA” and a “WTRU” may be used interchangeably herein.

Mechanisms to advertise the group enhanced data privacy (EDP) epoch parameters prior to association may be implemented. For example, an access point (AP) may advertise group EDP epoch parameters to a station (STA) informing its capabilities prior to association, including in roaming scenarios. A STA may select an AP for association using the received group EDP epoch parameters that matches its privacy requirements. A STA may inform an AP during the association process which group(s) the STA desires to join. In some examples, one embodiment may define element carrying lists of EDP epoch settings fields. One embodiment may include elements in the beacon frame to advertise group EDP epoch parameters. One embodiment may include elements in probe frames to advertise group EDP epoch parameters. One embodiment may modify the EDP group parameter frame format to carry the element defined in one or more of the above mentioned embodiments. One embodiment may include information on the group EDP epoch in the neighbor report element. One embodiment may present different implementations to include information on the group EDP epoch parameters in the reduced neighbor report.

IEEE 802.11 may provide mechanisms for the protection of the privacy of individuals using WLAN technology. For example, IEEE 802.11 may be configured to protect users from those who track them, for example, by protecting the possible identification of users as they roam to different locations and IEEE 802.11 networks. MAC (Medium Access Control) privacy features may be configured. MAC privacy features may protect the privacy of the user in non-associated state.

Embodiments may be implemented herein using MAC privacy procedures. Characteristics of IEEE 802.11 can be used to track users. Prior to association to an access point (AP), a station (STA) may define a MAC address that is used for the association. In some examples, the STA may use its hard-wired (e.g., device unique) MAC address for each of the associations. This behavior may make it trivial for the STA to be tracked, as observing the MAC address in pre-association messages and post-association messages may allow the tracking of the STA. For example, the MAC address may be present in transmissions (e.g., each transmission) sent by the STA and/or the MAC address may be unencrypted or unprotected from observations by other devices.

Other mechanisms may be used to track a STA in IEEE 802.11. For example, each frame in the sequence of frames sent by the STA to an AP may have a sequence number provided in the MAC header that is not encrypted or protected from observation. This sequence number may be used to track the STA even if the transmitting STA changed its MAC address since consecutive frames have consecutive sequence numbers. Other mechanisms may be more complex, such as the Orthogonal Frequency Division Multiplexing Physical Layer (OFDM PHY) data scrambler, which may also be tracked if not reseeded.

Enhancements to MAC Privacy may enable the STA to modify these parameters in pre-association state, in such a way that a user or device (e.g., STA) may not be trivially tracked while it roams before associating to an AP or when it changes network access. MAC Privacy enhancements may be implemented to mitigate this sort of traffic analysis, such that a STA may support the ability to periodically and randomly change its MAC addresses and reset counters and seeds prior to association. While discovering networks, a STA may refrain from gratuitously transmitting frames (e.g., probe request frames, association request frames, or other frames) including service set identifiers (SSIDs) of favored BSS networks.

Described herein are various examples for supporting MAC privacy enhancements. MAC address randomization may be applied by including any combination of the embodiments described herein. The STA may periodically change its MAC address to a random value while not associated to a BSS. The STA may construct the randomized MAC address from the locally administered address space. The non-AP STA may not change its MAC address during a transactional exchange, for example, transmitting public action frames for pre-association discovery, or during the creation of state on an AP using pre-association capabilities, for example, Robust Security Network (RSN) pre-authentication or Fast BSS Transition (FT) over-the-Distribution System (DS). If a non-AP STA starts any transaction that establishes state bound to a MAC address and decides to establish an association or a transaction state with a discovered BSS, the non-AP STA may change the MAC address to the one used to establish this state. State created with an AP using a prior MAC address, for instance, RSN pre-authentication state or FT state established over-the-DS, is bound to the MAC address used when that state was created. In some examples, when a MAC address is changed to another random value (e.g., each time the MAC address is changed to another random value), counters in all sequence number spaces used to identify each frame may be reset. The non-AP STA connecting to an infrastructure BSS may retain a single MAC address for the duration of its connection across an ESS.

IEEE 802.11 communications may implement mechanisms that address and improve user privacy. Modifications to the MAC mechanisms may preserve the existing services that might otherwise be restricted in environments where STAs in an ESS use randomized or changing MAC addresses, without affecting user privacy. IEEE 802.11 communications may implement mechanisms to enable session continuity in the absence of any unique MAC address-to-STA mapping.

Mechanisms may be implemented for an STA to discover available group EDP epochs in a BSS before association. In some examples, mechanisms may enable a STA, with prior knowledge of the group EDP epochs available, to signal in (Re)association frames the STA's desired EDP epoch parameters. The AP may provide the full set of EDP epoch parameters of the EDP epoch with similar characteristics during the (Re)association response. A different mechanism may enable an associated STA to gain information on the available EDP epochs by receiving an EDP group parameter frame from an AP, informing of all and/or a subset of the EDP epochs in use. These mechanisms may enable an STA to obtain the available EDP groups available during and after association. There may be other mechanisms described herein for enabling the STA to learn about the available EDP groups prior association. Knowledge of the available EDP groups prior association may be important for roaming purposes and/or to reduce the time required to be ready for transmission. Knowledge of the available EDP groups prior association may be important for the joining of the EDP group once a STA changes its AP.

The example methods described herein may include one or more of the following. For example, the methods may include a definition of an element enabling the transport of multiple EDP Epoch Settings fields in a compact way. The methods may include the element in beacons, probes, and/or EDP group parameter frames. The methods may include the EDP epoch settings field information in the neighbor report and/or reduced neighbor report (RNR).

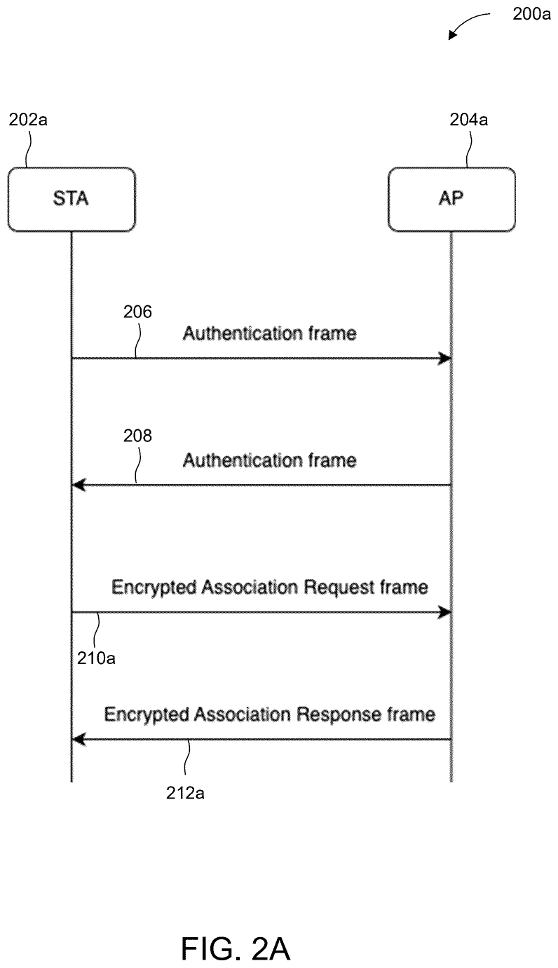

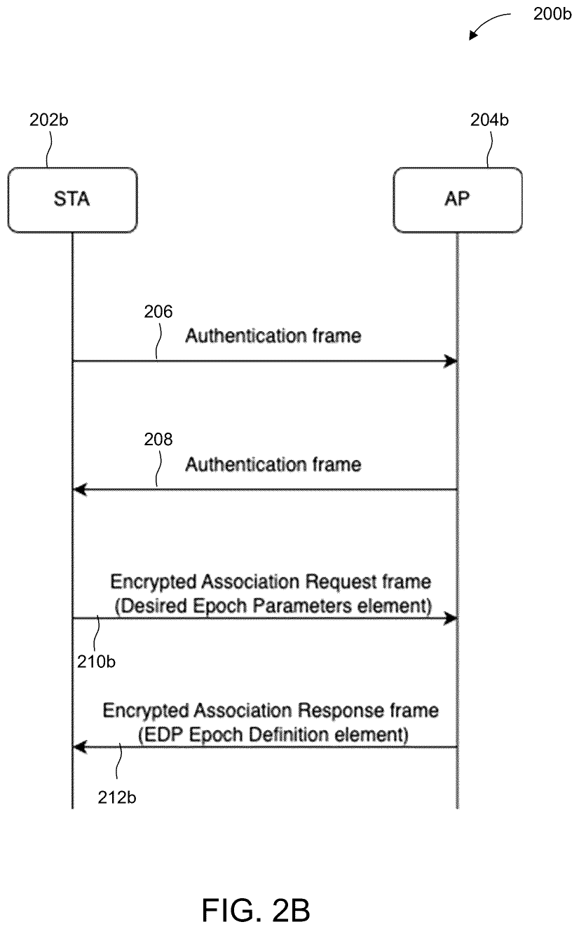

FIG. 2A is a system flow diagram illustrating an example association procedure 200a for associating a STA 202a and an AP 204a. As shown in FIG. 2A, the STA 202 a may send an authentication frame 206. The authentication frame 206 may be used to validate the device type of the STA. IEEE Std 802.11 attempts to control LAN access via the authentication service. IEEE 802.11 authentication is a station service. This service might be used by all STAs to establish their identity to STAs with which they communicate. If a mutually acceptable level of authentication has not been established between two STAs, an association is not established.

The AP 204a may send an authentication response frame 208. The authentication frame 206 and/or the authentication response frame 208 may include a shared key exchange or the authentication response frame 208 may include a shared key for enabling encrypted association request/response frames.

The STA 202a may transmit an encrypted association request frame 210a to the AP 204a. The encrypted association request frame 210a may include a minimum epoch pacing element. For example, in the protected association request frame 208, the STA 202a may indicate the minimum pacing element it supports, by adding a minimum epoch pacing element. The AP 204a may consider the minimum pacing element and may incorporate the STA 202a to the default epoch group, which parameters or configurations may be indicated in the protected association response frame 212a. The AP 204a may send to the STA 202a, in unicast, the information of the different epoch groups available through action frames including the enhanced group privacy availability element.

FIG. 2B is a system flow diagram illustrating an example association procedure 200b for associating a STA 202b and an AP 204b. As shown in FIG. 2B, the STA 202b may send the authentication frame 206 and the AP 200b may send an authentication response frame 208 if the STA 202b has the device capabilities to be associate with the AP 204b for performing 802.11 communications. The authentication frame 206 and/or the authentication response frame 208 may include a shared key exchange or the authentication response frame 208 may include a shared key for enabling encrypted association request/response frames.

The STA 202b may transmit an encrypted association request frame 210b that includes a desired epoch parameters element, as described herein. The desired epoch parameters element may include the desired parameter values for the STA 202b. The AP 204b may respond with an encrypted association response frame 212b. The encrypted association response frame 212b may identifies the EDP epoch definition element and the group ID for the assigned group epoch. The assigned group epoch may be a default epoch group when the desired epoch parameters fail to be satisfied. The assigned group epoch may be another epoch group managed by the AP 204b when the desired epoch parameters are satisfied by another epoch group.

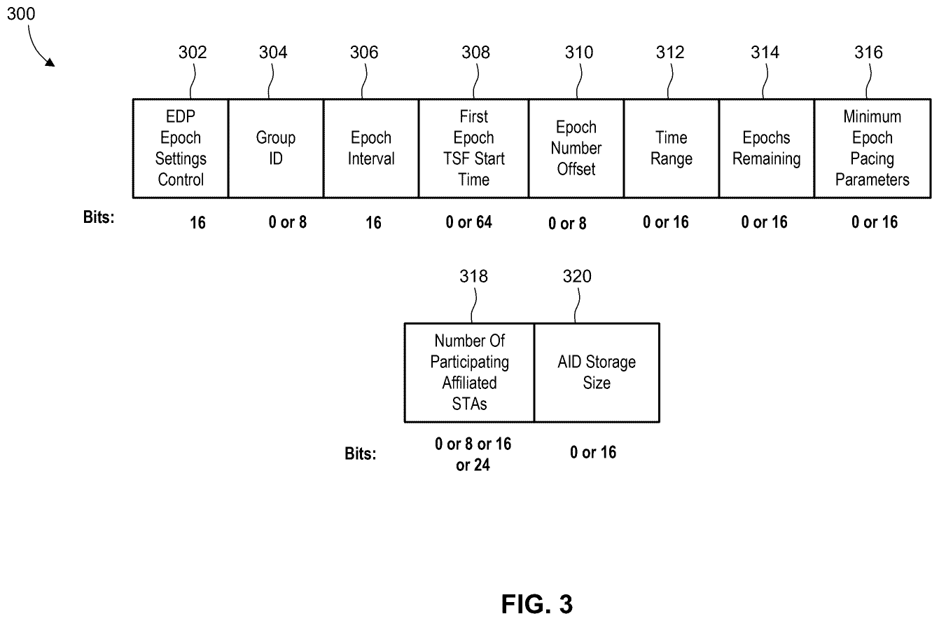

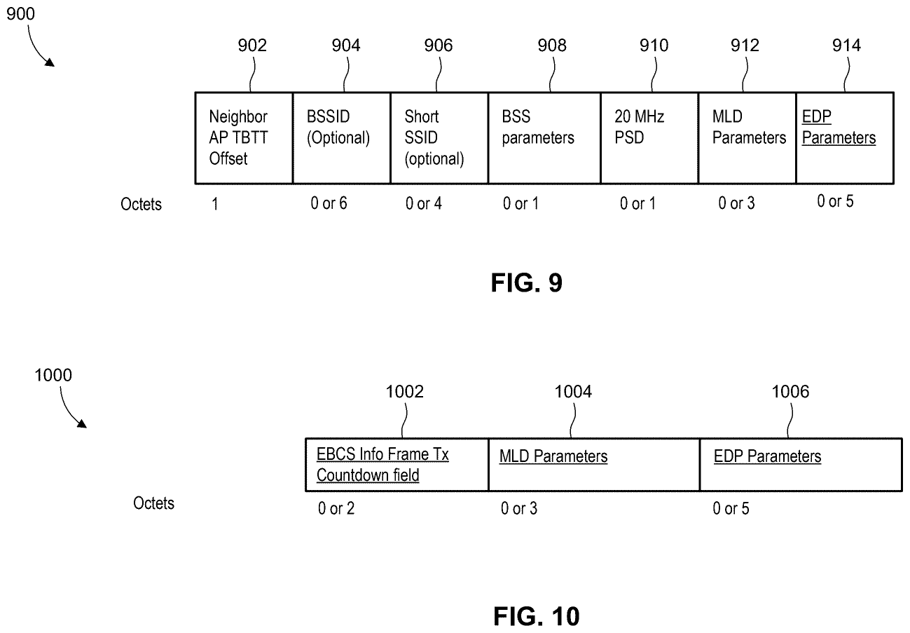

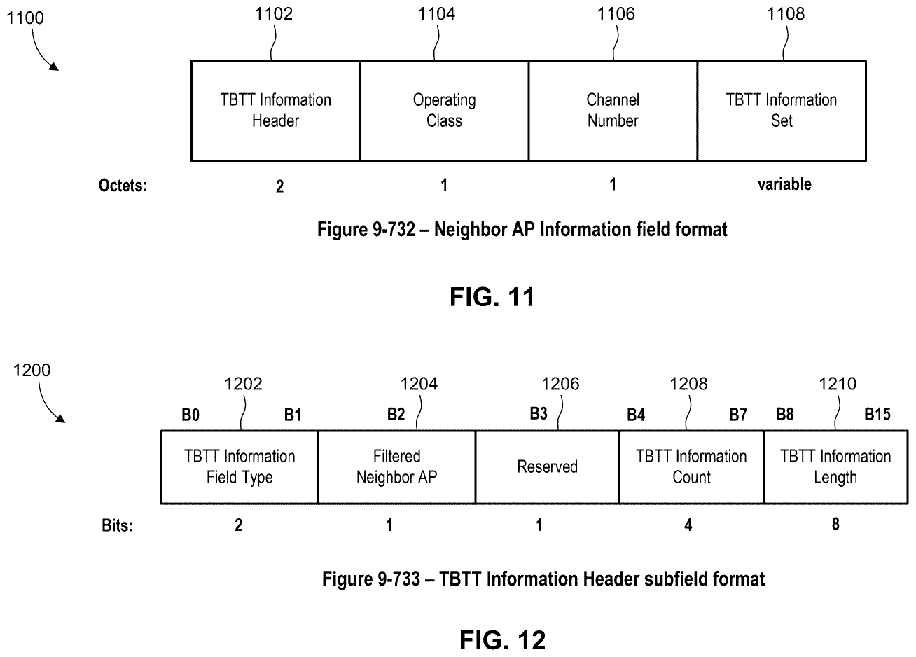

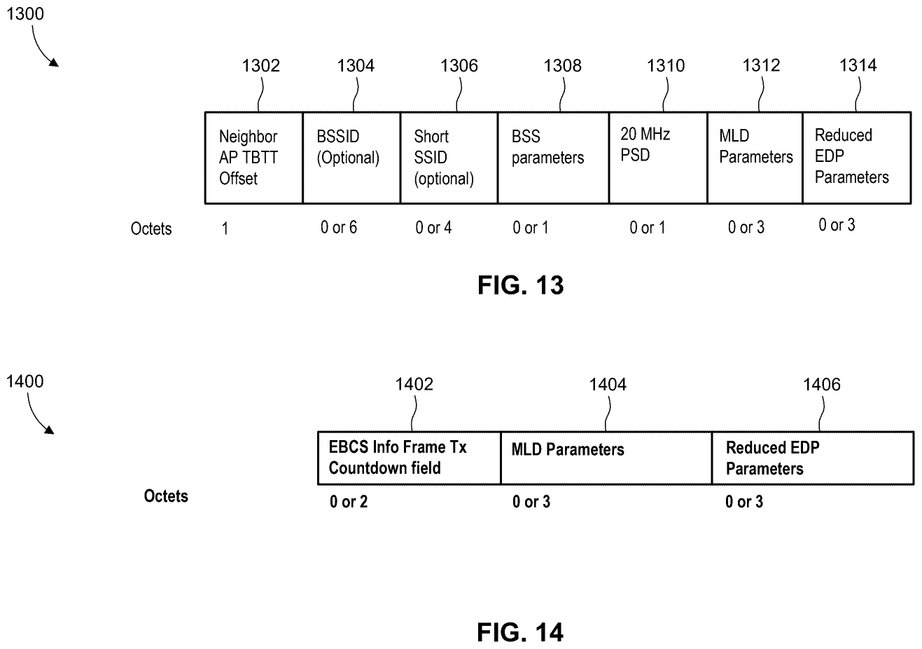

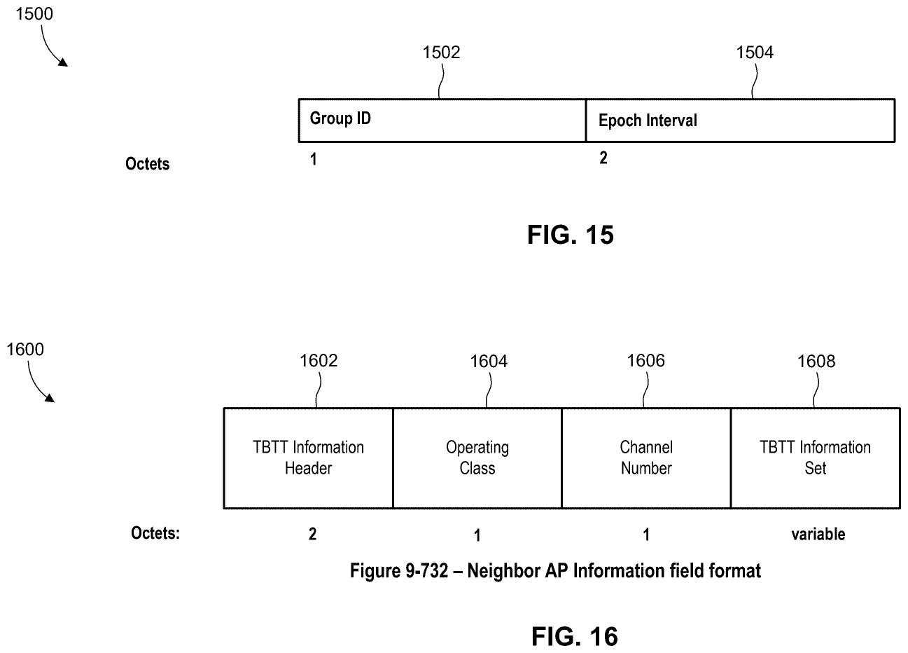

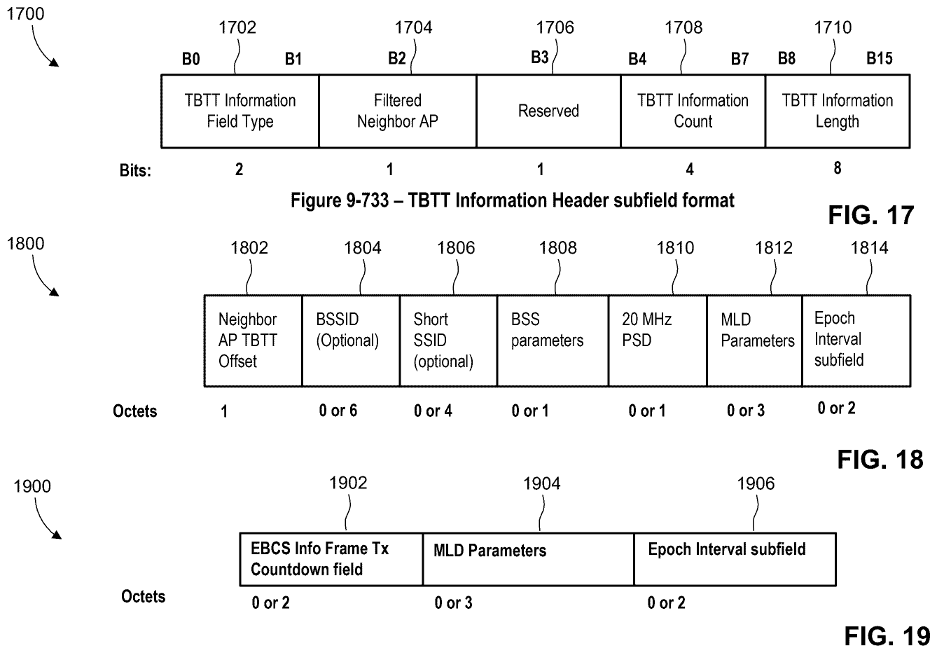

EDP epoch settings field and element may be implemented. The EDP epoch settings field may have the format as shown in FIG. 3 (e.g., FIG. 9-207n—EDP Epoch Settings field format), or similar format including one or more portions thereof. As shown in FIG. 3, the EDP Epoch Settings field format 300 may include EDP epoch settings control 302, group ID 304, epoch interval 306, first epoch TSF start time 308, epoch number offset 310, time range 312, epochs remaining 314, minimum epoch pacing parameters 316, number of participating affiliated STAs 318, and/or AID storage size 320. The EDP epoch settings field format 300 may be a very flexible field which may be adapted to different situations. For example, EDP epoch settings field 300 may be used to advertise the desired epoch parameters by a STA in association request frames and/or may be used to advertise the full set of parameters of the epoch in association response frames. Due to the flexibility in its format, its length may vary, for example, from 32 bits up to 25 octets. The epoch interval 306 may be the duration of an epoch in time units.

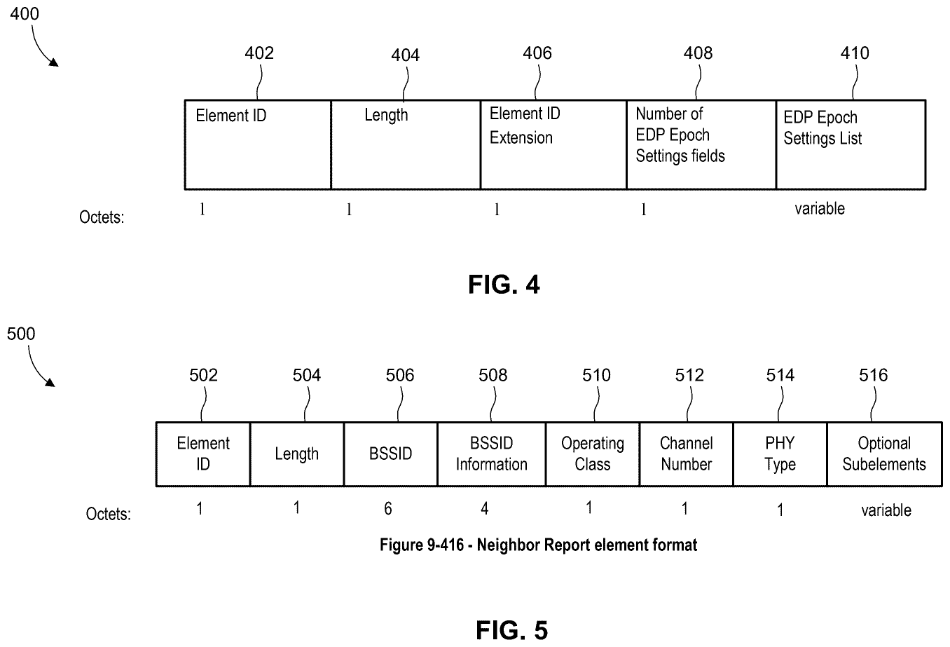

Definition of an element for lists of EDP Epoch Settings fields may be implemented. In some examples, the EDP list element may signal multiple EDP epoch settings fields. FIG. 4 is an example of a EDP list element 400. For example, the element ID 402, length 404 and element ID extension 406 fields of EDP list element 400 may be defined in the standards (e.g., general). The number of EDP epoch settings fields 408 may be an octet expressing the number of EDP epoch settings fields included in the EDP epoch settings list field. The EDP epoch settings list 410 field may include one or more EDP epoch settings fields, as defined in the standards (e.g., EDP epoch settings field). This element for lists of EDP epoch settings may be used herein.

Inclusion of EDP epoch parameters in beacons may be implemented. In some examples, to include the EDP epoch parameters information in beacons, Table 1 (e.g., 9-62 beacon frame body), including the EDP List element (as discussed above) and/or the EDP element may be extended.

TABLE 1
(TABLE 9-62 - Beacon frame format)
Beacon frame body

| Order | Information | Notes |
|---|---|---|
| 1 | Timestamp | See 9.4.1.10 (Timestamp field) |
| | | for Timestamp field format. |
| 2 | Beacon Interval | See 9.4.1.3 (Beacon Interval |
| | | field) for Beacon Interval field |
| | | format. |
| 3 | Capability Information | See 9.4.1.4 (Capability |
| | | Information field) for Capability |
| | | Information field format. |
| 4 | Service Set -Identifier (SSID) | If dot11MeshActivated is true, |
| | | the SSID element is the wildcard |
| | | value as described in 9.4.2.2 |
| | | (SSID element). |
| 5 | Supported Rates and BSS | |
| | Membership Selectors | |
| 6 | DSSS Parameter Set | The element is optionally |
| | | present. |
| | | The DSSS Parameter Set |
| | | element is present within Beacon |
| | | frames generated by STAs |
| | | using Clause 15 (DSSS PHY |
| | | specification for the 2.4 GHz |
| | | band designated for ISM - |
| | | applications), Clause 16 (High |
| | | rate direct sequence spread |
| | | spectrum (HR/DSSS) PHY - |
| | | specification), and Clause 18 |
| | | (Extended Rate PHY (ERP) |
| | | specification) PHYs. |
| | | The element is present within |
| | | Beacon frames generated by |
| | | STAs using a Clause 19 (High |
| | | Throughput (HT) PHY |
| | | specification(#2297)) PHY in the |
| | | 2.4 GHz band. |
| 7 | IBSS Parameter Set | The IBSS Parameter Set |
| | | element is present only within |
| | | Beacon frames generated by |
| | | IBSS STAS. |
| 8 | Traffic indication map (TIM) | The TIM element is present only |
| | | within Beacon frames generated |
| | | by APs or mesh STAs. |
| 9 | Country | The Country element is present if |
| | | dot11MultiDomainCapabilityActivated |
| | | is true or |
| | | dot11SpectrumManagementRequired |
| | | is true or |
| | | dot11RadioMeasurementActivated |
| | | is true. |
| 10 | Power Constraint | The Power Constraint element is |
| | | present if |
| | | dot11SpectrumManagementRequired |
| | | is true and is optionally |
| | | present if |
| | | dot11RadioMeasurementActivated |
| | | is true. |
| 11 | Channel Switch Announcement | (#3085) The Channel Switch |
| | | Announcement element is |
| | | optionally present if |
| | | dot11SpectrumManagementRequired |
| | | is true or |
| | | dot11ExtendedChannelSwitchActivated |
| | | is true.(#511) |
| 12 | Quiet | The Quiet element is optionally |
| | | present if |
| | | dot11SpectrumManagementRequired |
| | | is true or |
| | | dot11RadioMeasurementActivated |
| | | is true. |
| 13 | IBSS DFS | IBSS DFS element is present if |
| | | dot11SpectrumManagementRequired |
| | | is true in an IBSS. |
| 14 | TPC Report | The TPC Report element is |
| | | present if |
| | | dot11SpectrumManagementRequired |
| | | is true or |
| | | dot11RadioMeasurementActivated |
| | | is true. |
| 15 | ERP | The ERP element is present |
| | | within Beacon frames generated |
| | | by STAs using extended rate |
| | | PHYs (ERPs) defined in |
| | | Clause 18 (Extended Rate PHY |
| | | (ERP) specification) and is |
| | | optionally present in other cases. |
| 16 | Extended Supported Rates and | (#3086)The Extended Supported |
| | BSS Membership Selectors | Rates and BSS Membership |
| | | Selectors element is present if |
| | | the number of supported rates |
| | | and BSS membership |
| | | selectors(#1470) together |
| | | exceed eight; it is optional |
| | | otherwise. |
| 17 | RSN | The RSNE is present if |
| | | dot11RSNAActivated is true; |
| | | otherwise not present.(#3400) |
| 18 | BSS Load | The BSS Load element is |
| | | present if |
| | | dot11QosOptionImplemented |
| | | and |
| | | dot11QBSSLoadImplemented |
| | | are both true. |
| 19 | EDCA Parameter Set | The EDCA Parameter Set |
| | | element is present if |
| | | dot11QosOptionImplemented is |
| | | true, dot11MeshActivated is |
| | | false, and the QoS Capability |
| | | element is not present; |
| | | otherwise, it is not present.(11ax) |
| 20 | QoS Capability | The QoS Capability element is |
| | | present if |
| | | dot11QosOptionImplemented is |
| | | true, dot11MeshActivated is |
| | | false, and neither the EDCA |
| | | Parameter Set element nor the |
| | | MU EDCA Parameter Set |
| | | element is present; otherwise, it |
| | | is not present.(11ax) |
| 21 | AP Channel Report | If |
| | | dot11RMAPChannelReportActivated |
| | | is true, one AP Channel |
| | | Report element is present for |
| | | each operating class that has at |
| | | least 1 channel to report. |
| 22 | BSS Average Access Delay | The BSS Average Access Delay |
| | | element is present if |
| | | dot11RMBSSAverageAccessDelayActivated |
| | | is true and the AP |
| | | Average Access Delay field is |
| | | not equal to 255 (measurement |
| | | not available); otherwise, the |
| | | BSS Average Access Delay |
| | | element is optionally present if |
| | | dot11RMBSSAverageAccessDelayActivated |
| | | is true. |
| 23 | Antenna | The Antenna element is present |
| | | if |
| | | dot11RMAntennaInformationActivated |
| | | is true and the Antenna ID |
| | | field is not equal to 0 (unknown |
| | | antenna); otherwise, the Antenna |
| | | element is optionally present if |
| | | dot11RMAntennaInformationActivated |
| | | is true. |
| 24 | BSS Available Admission | The BSS Available Admission |
| | Capacity | Capacity element is present if |
| | | dot11RMBSSAvailableAdmissionCapacityActivated |
| | | is true with the |
| | | following exceptions: 1) when |
| | | Available Admission Capacity |
| | | Bitmask equals 0 (Available |
| | | Admission Capacity List contains |
| | | no entries), or 2) when the BSS |
| | | Load element is present and the |
| | | Available Admission Capacity |
| | | Bitmask states that only AC_VO |
| | | is present in the Available |
| | | Admission Capacity List field. |
| 25 | BSS AC Access Delay | The BSS AC Access Delay |
| | | element is present if |
| | | dot11RMBSSAverageAccessDelayActivated |
| | | is true and at least |
| | | one field of the element is not |
| | | equal to 255 (measurement not |
| | | available); otherwise, the BSS |
| | | AC Access Delay element is |
| | | optionally present if |
| | | dot11RMBSSAverageAccessDelayActivated |
| | | is true. |
| 26 | Measurement Pilot Transmission | The Measurement Pilot |
| | | Transmission element is present |
| | | if |
| | | dot11RMMeasurementPilotActivated |
| | | is a value between 2 and 7. |
| 27 | Multiple BSSID | (#488)One or more Multiple |
| | | BSSID elements are present if |
| | | the AP is a member of multiple |
| | | BSSID set (see 11.10.14 |
| | | (Multiple BSSID set)) with two or |
| | | more members and any of the |
| | | following conditions are true: |
| | | dot11MultiBSSIDImplemented |
| | | is true |
| | | dot11MultiBSSIDImplemented |
| | | is false and |
| | | dot11RMMeasurementPilotActivated |
| | | is between 2 and 7 |
| | | dot11FILSActivated is true |
| | | dot11InterworkingServiceActivated |
| | | is true and at least one |
| | | dot11GASAdvertisementID |
| | | exists |
| 28 | RM Enabled Capabilities | RM Enabled Capabilities element |
| | | is present if |
| | | dot11RadioMeasurementActivated |
| | | is true. |
| 29 | Mobility Domain | The (#1776)MDE is present if |
| | | dot11FastBSSTransitionActivated |
| | | is true. |
| 30 | DSE registered location | The DSE Registered Location |
| | | element is present if |
| | | dot11LCIDSERequired is true. |
| 31 | Extended Channel Switch | The Extended Channel Switch |
| | Announcement | Announcement element is |
| | | optionally present if |
| | | dot11ExtendedChannelSwitchActivated |
| | | is true. |
| 32 | Supported Operating Classes | The Supported Operating |
| | | Classes element is present if |
| | | dot11ExtendedChannelSwitchActivated or |
| | | dot11OperatingClassesRequired |
| | | is true. |
| | | The Supported Operating |
| | | Classes element is optionally |
| | | present if |
| | | dot11TVHTOptionImplemented |
| | | is true. |
| 33 | HT Capabilities | The HT Capabilities element is |
| | | present when |
| | | dot11HighThroughputOptionImplemented |
| | | is true and the STA is |
| | | not a STA 6G.(11ax) |
| 34 | HT Operation | The HT Operation element is |
| | | included by an AP and a mesh |
| | | STA when |
| | | dot11HighThroughputOptionImplemented |
| | | is true and the AP or |
| | | mesh STA is not a STA 6G.(11ax) |
| 35 | 20/40 BSS Coexistence | The 20/40 BSS Coexistence |
| | | element is optionally present |
| | | when |
| | | dot112040BSSCoexistenceManagementSupport |
| | | is true. |
| 36 | Overlapping BSS Scan | The Overlapping BSS Scan |
| | Parameters | Parameters element is optionally |
| | | present if |
| | | dot11FortyMHzOptionImplemented |
| | | is true. |
| 37 | Extended Capabilities | The Extended Capabilities |
| | | element is present if any of the |
| | | fields in this element are |
| | | nonzero. |
| 38 | FMS Descriptor | The FMS Descriptor element is |
| | | present if dot11FMSActivated is true. |
| 39 | QoS Traffic Capability | The QoS Traffic Capability |
| | | element is optionally present if |
| | | dot11ACStationCountActivated is true. |
| 40 | Time Advertisement | The Time Advertisement element |
| | | is present every |
| | | dot11TimeAdvertisementDTIMInterval if |
| | | dot11UTCTSFOffsetActivated is true. |
| 41 | Interworking | The Interworking element is |
| | | present if |
| | | dot11InterworkingServiceActivated |
| | | is true. |
| 42 | Advertisement Protocol | Advertisement Protocol element |
| | | is present if |
| | | dot11InterworkingServiceActivated |
| | | is true and at least one |
| | | dot11GASAdvertisementID MIB |
| | | attribute exists. |
| 43 | Roaming Consortium | The Roaming Consortium |
| | | element is present if |
| | | dot11InterworkingServiceActivated |
| | | is true and the |
| | | dot11RoamingConsortiumTable |
| | | has at least one entry. |
| 44 | Emergency Alert Identifier | One or more Emergency Alert |
| | | Identifier elements are present if |
| | | dot11EASActivated is true and |
| | | there are one or more EAS |
| | | message(s) active in the network. |
| 45 | Mesh ID | The Mesh ID element is present |
| | | if dot11MeshActivated is true. |
| 46 | Mesh Configuration | The Mesh Configuration element |
| | | is present if dot11MeshActivated |
| | | is true. |
| 47 | Mesh Awake Window | The Mesh Awake Window |
| | | element is optionally present if |
| | | dot11MeshActivated is true. |
| 48 | Beacon Timing | The Beacon Timing element is |
| | | optionally present if both |
| | | dot11MeshActivated and |
| | | dot11MBCAActivated are true. |
| 49 | MCCAOP Advertisement | The MCCAOP Advertisement |
| | Overview | Overview element is optionally |
| | | present if both |
| | | dot11MeshActivated and |
| | | dot11MCCAActivated are true. |
| 50 | MCCAOP Advertisement | One or more MCCAOP |
| | | Advertisement elements are |
| | | optionally present if both |
| | | dot11MeshActivated and |
| | | dot11MCCAActivated are true. |
| 51 | Mesh Channel Switch | The Mesh Channel Switch |
| | Parameters | Parameters element is present |
| | | when dot11MeshActivated is true |
| | | and either Channel Switch |
| | | Announcement element or |
| | | Extended Channel Switch |
| | | Announcement element is present. |
| 52 | QMF Policy | Indicates the QMF policy |
| | | parameters of the transmitting |
| | | STA. The QMF Policy element is |
| | | present when |
| | | dot11QMFActivated is true and |
| | | the transmitting STA is an AP or |
| | | a mesh STA. This element is not |
| | | present otherwise. |
| 53 | QLoad Report | The QLoad Report element is |
| | | present every |
| | | dot11QLoadReportIntervalDTIM |
| | | DTIM intervals(#4221) if |
| | | dot11QLoadReportActivated is |
| | | true. |
| 54 | HCCA TXOP Update Count | The HCCA TXOP Update Count |
| | | element is present if both |
| | | dot11PublicHCCATXOPNegotiationActivated |
| | | is true and an HC is |
| | | (#2210) colocated with the AP. |
| 55 | Multi-band | The Multi-band element is |
| | | optionally present if |
| | | dot11MultibandImplemented is |
| | | true. |
| 56 | VHT Capabilities | The VHT Capabilities element is |
| | | present when |
| | | dot11VHTOptionImplemented is |
| | | true and the STA is not a STA |
| | | 6G.(11ax) |
| 57 | VHT Operation | The VHT Operation element is |
| | | present when |
| | | dot11VHTOptionImplemented is |
| | | true and the STA is not a STA |
| | | 6G and is optionally present if |
| | | dot11HEOptionImplemented is |
| | | true; otherwise, it is not |
| | | present.(11ax) |
| 58 | Transmit Power Envelope(#474) | (11ax)One Transmit Power |
| | | Envelope element is present for |
| | | each distinct |
| | | combination of values of the |
| | | Maximum Transmit Power |
| | | Interpretation subfield and |
| | | Maximum Transmit Power |
| | | Category subfield that is |
| | | supported for the BSS if both of |
| | | the following conditions are met: |
| | | Either |
| | | dot11VHTOptionImplemented or |
| | | dot11ExtendedSpectrumManagementImplemented |
| | | is true. |
| | | Either |
| | | dot11SpectrumManagementRequired |
| | | is true or |
| | | dot11RadioMeasurementActivated |
| | | is true. |
| | | Otherwise, this element is not |
| | | present. |
| | | NOTE-In a 6 GHz HE AP, both |
| | | dot11VHTOptionImplemented |
| | | (see 26.17.1 (Basic HE BSS |
| | | operation)) and |
| | | dot11SpectrumManagementRequired |
| | | (see 26.17.2.1 (General)) |
| | | are true. |
| 59 | Channel Switch Wrapper(#474) | The Channel Switch Wrapper |
| | | element is optionally present if |
| | | dot11VHTOptionImplemented or |
| | | dot11ExtendedSpectrumManagementImplemented |
| | | is true and at |
| | | least one of a Channel Switch |
| | | Announcement element or an |
| | | Extended Channel Switch |
| | | Announcement element is also |
| | | present in the Beacon frame and |
| | | the Channel Switch Wrapper |
| | | element contains at least one |
| | | subelement. |
| 60 | Extended BSS Load(#474) | The Extended BSS Load |
| | | element is optionally present if |
| | | dot11QBSSLoadImplemented |
| | | and |
| | | dot11VHTOptionImplemented |
| | | are both true.(#3338)(#4130) |
| 61 | Quiet Channel | Either one Quiet Channel |
| | | element containing an AP Quiet |
| | | Mode field equal to 0 or, in an |
| | | infrastructure BSS, one or more |
| | | Quiet Channel elements each |
| | | containing an AP Quiet Mode |
| | | field equal to 1 are optionally |
| | | present if |
| | | dot11VHTOptionImplemented is |
| | | true, and either |
| | | dot11SpectrumManagementRequired or |
| | | dot11RadioMeasurementActivated |
| | | is true. |
| 62 | Operating Mode Notification | The Operating Mode Notification |
| | | element is optionally present if |
| | | dot11OperatingModeNotificationImplemented |
| | | is true. |
| 63 | Reduced Neighbor Report | One or more Reduced Neighbor |
| | | Report elements are optionally |
| | | present if |
| | | dot11TVHTOptionImplemented, |
| | | dot11FILSActivated, or |
| | | dot11ColocatedRNRImplemented |
| | | is true; otherwise, they are not |
| | | present.(11ax) |
| 64 | TVHT Operation | The TVHT Operation element is |
| | | present for a (#4096)STA when |
| | | dot11TVHTOptionImplemented |
| | | is true; otherwise it is not |
| | | present. |
| 65 | Estimated Service Parameters | The Estimated Service |
| | Inbound | Parameters Inbound element is |
| | | present if |
| | | dot11EstimatedServiceParametersInboundOptionImplemented |
| | | is true. |
| 66 | Future Channel Guidance | The Future Channel Guidance |
| | | element is optionally present if |
| | | dot11FutureChannelGuidanceActivated |
| | | is true. |
| 67 | Common Advertisement Group | The CAG Number element is |
| | (CAG) Number | optionally present if |
| | | dot11FILSActivated is true; |
| | | otherwise not present. |
| 68 | FILS Indication | The FILS Indication element is |
| | | present if dot11FILSActivated is |
| | | true; otherwise not present. |
| 69 | AP-CSN | (#1776)The AP-CSN element is |
| | | optionally present if |
| | | dot11FILSActivated is true; |
| | | otherwise not present. |
| 70 | DILS | The DILS element is optionally |
| | | present if dot11FILSActivated is |
| | | true; otherwise not present. |
| 71 | Max Channel Switch Time | The Max Channel Switch Time |
| | | element is optionally present |
| | | when a Channel Switch |
| | | Announcement or an Extended |
| | | Channel Switch Announcement |
| | | element is also present. |
| 72 | Estimated Services | The Estimated Service |
| | Parameters Outbound | Parameters Outbound element is |
| | | optionally present if |
| | | dot11EstimatedServiceParametersOutboundOptionImplemented |
| | | is true. |
| 73 | Service Hint | The Service Hint element is |
| | | optionally present if |
| | | dot11UnsolicitedPADActivated is |
| | | true. |
| 74 | Service Hash | The Service Hash element is |
| | | optionally present if |
| | | dot11UnsolicitedPADActivated is |
| | | true. |
| 75 | RSN Extension | The RSNXE is present if any |
| | | subfield of the Extended RSN |
| | | Capabilities field in this element |
| | | is nonzero, except the Field |
| | | Length subfield. |
| 76(11ax) | Multiple BSSID Configuration | The Multiple BSSID |
| | | Configuration element is |
| | | optionally present if |
| | | dot11MultiBSSIDImplemented is |
| | | true. |
| 77(11ax) | HE Capabilities | The HE Capabilities element is |
| | | present if |
| | | dot11HEOptionImplemented is |
| | | true; otherwise, it is not present. |
| 78(11ax) | HE Operation | The HE Operation element is |
| | | present if |
| | | dot11HEOptionImplemented is |
| | | true; otherwise, it is not present. |
| 79(11ax) | TWT | The TWT element is optionally |
| | | present if |
| | | dot11TWTOptionActivated is |
| | | true; otherwise, it is not present. |
| 80(11ax) | UORA Parameter Set | The UORA Parameter Set |
| | | element is optionally present if |
| | | dot11OFDMARandomAccessOptionImplemented |
| | | is true; |
| | | otherwise, it is not present. |
| 81(11ax) | BSS Color Change | The BSS Color Change |
| | Announcement | Announcement element is |
| | | optionally present if |
| | | dot11HEOptionImplemented is |
| | | true; otherwise, it is not present. |
| 82(11ax) | Spatial Reuse Parameter Set | The Spatial Reuse Parameter |
| | | Set element is optionally present |
| | | if dot11HEOptionImplemented is |
| | | true; otherwise, it is not present. |
| 83 | MU EDCA Parameter Set | The MU EDCA Parameter Set |
| | | element is present if |
| | | dot11HEOptionImplemented is |
| | | true, dot11MeshActivated is false, |
| | | dot11MUEDCAParametersActivated |
| | | is true, and the QoS |
| | | Capability element is not present; |
| | | otherwise, it is not present. |
| 84(11ax) | ESS Report | The ESS Report element is |
| | | optionally present. |
| 85(11ax) | NDP Feedback Report | The NDP Feedback Report |
| | Parameter Set | Parameter Set element is |
| | | optionally present if |
| | | dot11HEOptionImplemented is |
| | | true; otherwise, it is not present. |
| 86(11ax) | HE BSS Load | The HE BSS Load element is |
| | | optionally present if |
| | | dot11QBSSLoadImplemented |
| | | and dot11HEOptionImplemented |
| | | are true. |
| 87(11ax) | HE 6 GHz Band Capabilities | The HE 6 GHz Band Capabilities |
| | | element is present if |
| | | dot11HEOptionImplemented and |
| | | dot11HE6GOptionImplemented |
| | | are true. |
| 88(11ax) | TWT Constraint Parameters | The TWT Constraint Parameters |
| | | element is optionally present if |
| | | dot11TWTOptionActivated is |
| | | true; otherwise, it is not present. |
| 89(11ba) | WUR Capabilities | The WUR Capabilities element is |
| | | present when |
| | | dot11WUROptionImplemented is |
| | | true; otherwise it is not present. |
| 90(11ba) | WUR Operation | The WUR Operation element is |
| | | present when |
| | | dot11WUROptionImplemented is |
| | | true; otherwise it is not present. |
| 91(11ba) | WUR Discovery | The WUR Discovery element is |
| | | optionally present |
| | | if dot11WUROptionImplemented |
| | | is true and either |
| | | dot11WURDiscoveryImplemented or |
| | | dot11WURNeighborDiscoveryImplemented |
| | | is true; otherwise it is |
| | | not present. |
| 92(11az) | RSTA Availability Window | The RSTA Availability Window |
| | | element is optionally present if |
| | | dot11PassiveTBRangingResponderImplemented |
| | | is true and a |
| | | passive TB ranging availability |
| | | window is present. |
| 93(11bc) | EBCS Parameters | This element is present if |
| | | dot11EBCSSupportActivated is |
| | | true and the length of |
| | | dot11EBCSTrafficStreamTable is |
| | | larger than 0, otherwise not |
| | | present. |
| 94(11bc) | EBCS TIM | The EBCS TIM is present if |
| | | dot11EBCSSupportActivated is |
| | | true, |
| | | dot11EBCSTIMInBeaconActivated |
| | | is true, and one or more BUs |
| | | for an EBCS traffic stream for |
| | | which |
| | | dot11EBCSTrafficStreamBuffered |
| | | is true are buffered, otherwise |
| | | not present. |
| 95 (This is an | EDP List | The EDP List element is present |
| example of numbering; | | if the |
| exact number will be | | dot11EDPGroupEpochActivated |
| provided by IANA | | is true; otherwise, it is not |
| in the future) | | present. This element carries a |
| | | list of EDP Epoch Settings fields |
| | | including the parameters of the |
| | | different EDP epochs available in |
| | | the BSS. |
| 96 (This is an | EDP | The EDP element (see 9.4.2.348- |
| example of numbering; | | EDP element) is present if the |
| exact number will be | | |
| provided by IANA | | |
| in the future) | | |
| Last - 1 | Vendor Specific | One or more Vendor Specific |
| | | elements are optionally |
| | | present.(#245) |
| Last | MME | The MME is present if |
| | | dot11BeaconProtectionEnabled |
| | | is true at the AP. |

NOTE-
The MME appears last in the frame body to protect the frames as specified in 12.5.3 (Broadcast/multicast integrity protocol (BIP)). Since it appears last and has a fixed size, it can readily be located without parsing all the elements in the frame.(#7154)

In some examples, and/or considering the flexibility of the EDP epoch settings field, the EDP list element (as discussed above) and/or the EDP element, carried in a beacon frame may include EDP Epoch Settings fields with all possible information of the EDP epoch (e.g., full set of EDP epoch parameters), partial information, and/or may include a reduced version of it. For example, the reduced version of the EDP epoch settings fields may include an EDP epoch settings control, an EDP group ID, and/or an epoch interval. For example, each different EDP epoch settings field included in the EDP list element or EDP element may or may not include all the fields or a combination of them.

In some examples, different EDP Epoch settings fields within an EDP List element may have a different structure and/or contain different subfields. In a different implementation, an AP may include in its beacon frames an EDP element, for example, to advertise the default EDP group. A different implementation may signal the different parameters for the epoch groups using any of the information defined in the EDP element but as a separated element and/or subfield (e.g., not element). For example, one implementation may include the group ID and the Epoch interval in its beacon frames.

In some examples, beacon frames may be periodic broadcast messages from an access point that informs nearby devices (e.g., STAs) about the existence, capabilities, and/or configuration of a wireless network. Beacon frames may enable discovery, synchronization, and/or efficient communication. For example, with respect to including EDP parameters in beacon frames, as described herein, a STA may be able to understand the different EDP groups available in the AP and/or BSS. This information may be used later during the association process to indicate to the AP the group the STA desires to join.

Inclusion of EDP epoch parameters in probe response frames may be implemented. In some examples, to include the EDP epoch parameters information in probe Response frames, we may extend Table 2 (e.g., 9-69—Probe Response frame body), including the EDP list element (as discussed above) and/or the EDP element.

### Order Information Notes

TABLE 2
(Table 9-69 - Probe Response frame body)

| Order | Information | Notes |
|---|---|---|
| 1 | Timestamp | See 9.4.1.10 (Timestamp field) |
| | | for Timestamp field format. |
| 2 | Beacon Interval | See 9.4.1.3 (Beacon Interval |
| | | field) for Beacon Interval field |
| | | format. |
| 3 | Capability Information | See 9.4.1.4 (Capability |
| | | Information field) for Capability |
| | | Information field format. |
| 4 | SSID | If dot11MeshActivated is true, |
| | | the SSID element is the wildcard |
| | | value as described in 9.4.2.2 |
| | | (SSID element). |
| 5 | Supported Rates and BSS | (#1659)If |
| | Membership Selectors | dot11S1GOptionImplemented or |
| | | dot11DMGOptionImplemented is |
| | | true, this element ought not be |
| | | present unless one or more BSS |
| | | membership selectors (see |
| | | 11.1.4.6 (Operation of Supported |
| | | Rates and BSS Membership |
| | | Selectors element and Extended |
| | | Supported Rates and BSS |
| | | Membership Selectors element) |
| | | are indicated.(#24) |
| 6 | DSSS Parameter Set | The element is optionally |
| | | present. |
| | | The DSSS Parameter Set |
| | | element is present within Probe |
| | | Response frames generated by |
| | | STAs using Clause 15 (DSSS |
| | | PHY specification for the |
| | | 2.4 GHz band designated for |
| | | ISM -applications), Clause 16 |
| | | (High rate direct sequence |
| | | spread spectrum (HR/DSSS) |
| | | PHY -specification), and |
| | | Clause 18 (Extended Rate PHY |
| | | (ERP) specification) PHYs. |
| | | The DSSS Parameter Set |
| | | element is present within Probe |
| | | Response frames generated by |
| | | STAs using a Clause 19 (High |
| | | Throughput (HT) PHY |
| | | specification(#2297)) PHY in the |
| | | 2.4 GHz band. |
| 7 | IBSS Parameter Set | The IBSS Parameter Set |
| | | element is present only within |
| | | Probe Response frames |
| | | generated by IBSS STAs. |
| 8 | Country | The Country element is |
| | | present if |
| | | dot11MultiDomainCapabilityActivated |
| | | is true or |
| | | dot11SpectrumManagementRequired |
| | | is true or |
| | | dot11RadioMeasurementActivated |
| | | is true. |
| 9 | Power Constraint | The Power Constraint element is |
| | | present if |
| | | dot11SpectrumManagementRequired |
| | | is true and is optionally |
| | | present if |
| | | dot11RadioMeasurementActivated |
| | | is true. |
| 10 | Channel Switch Announcement | (#3087)The Channel Switch |
| | | Announcement element is |
| | | optionally present if |
| | | dot11SpectrumManagementRequired |
| | | is true or |
| | | dot11ExtendedChannelSwitchActivated |
| | | is true.(#511) |
| 11 | Quiet | The Quiet element is optionally |
| | | present if |
| | | dot11SpectrumManagementRequired |
| | | is true or if |
| | | dot11RadioMeasurementActivated |
| | | is true. |
| 12 | IBSS DFS | The IBSS DFS element is |
| | | present if |
| | | dot11SpectrumManagementRequired |
| | | is true in an IBSS. |
| 13 | TPC Report | The TPC Report element is |
| | | present if |
| | | dot11SpectrumManagementRequired |
| | | is true or |
| | | dot11RadioMeasurementActivated |
| | | is true. |
| 14 | ERP | The ERP element is present |
| | | within Probe Response frames |
| | | generated by STAs using ERPs |
| | | and is optionally present |
| | | otherwise. |
| 15 | Extended Supported Rates and | (#3086)The Extended Supported |
| | BSS Membership Selectors | Rates and BSS Membership |
| | | Selectors element is present if |
| | | the number of supported rates |
| | | and BSS membership |
| | | selectors(#1470) together |
| | | exceed eight; it is optional |
| | | otherwise. |
| | | (#1659)If |
| | | dot11S1GOptionImplemented or |
| | | dot11DMGOptionImplemented is |
| | | true, this element ought not be |
| | | present unless there are more |
| | | than 8 BSS membership |
| | | selectors (see 11.1.4.6 |
| | | (Operation of Supported Rates |
| | | and BSS Membership Selectors |
| | | element and Extended |
| | | Supported Rates and BSS |
| | | Membership Selectors element) |
| | | indicated.(#24) |
| 16 | RSN | The RSNE is present if |
| | | dot11RSNAActivated is true; |
| | | otherwise not present. |
| 17 | BSS Load | The BSS Load element is |
| | | present if |
| | | dot11QosOptionImplemented |
| | | and |
| | | dot11QBSSLoadImplemented |
| | | are both true. |
| 18 | EDCA Parameter Set | The EDCA Parameter Set |
| | | element is present if |
| | | dot11QosOptionImplemented is |
| | | true and dot11MeshActivated is |
| | | false. |
| 19 | Measurement Pilot | The Measurement Pilot |
| | Transmission | Transmission element is present if |
| | | dot11RMMeasurementPilotActivated |
| | | is between 2 and 7. |
| 20 | Multiple BSSID | (#488)One or more Multiple |
| | | BSSID elements are present if |
| | | the AP is a member of a multiple |
| | | BSSID set (see 11.10.14 |
| | | (Multiple BSSID set)) with two or |
| | | more members and any of the |
| | | following conditions are true: |
| | | dot11MultiBSSIDImplemented |
| | | is true |
| | | dot11MultiBSSIDImplemented |
| | | is false and |
| | | dot11RMMeasurementPilotActivated |
| | | is between 2 and 7 |
| | | dot11FILSActivated is true |
| | | dot11InterworkingServiceActivated |
| | | is true and at least one |
| | | dot11GASAdvertisementID |
| | | exists |
| 21 | RM Enabled Capabilities | The RM Enabled Capabilities |
| | | element is present if |
| | | dot11RadioMeasurementActivated |
| | | is true. |
| 22 | AP Channel Report | If |
| | | dot11RMAPChannelReportActivated |
| | | is true, one AP Channel |
| | | Report element is optionally |
| | | present for each operating class |
| | | that has at least 1 channel to |
| | | report. |
| 23 | BSS Average Access Delay | The BSS Average Access Delay |
| | | element is optionally present if |
| | | dot11RMBSSAverageAccessDelayActivated |
| | | is true and the AP |
| | | Average Access Delay field is |
| | | not equal to 255 (measurement |
| | | not available). |
| 24 | Antenna | The Antenna element is |
| | | optionally present if |
| | | dot11RMAntennaInformationActivated |
| | | is true and the Antenna ID |
| | | field is not equal to 0 (unknown |
| | | antenna). |
| 25 | BSS Available Admission | The BSS Available Admission |
| | Capacity | Capacity element is optionally |
| | | present if |
| | | dot11RMBSSAvailableAdmissionCapacityActivated |
| | | is true with the |
| | | following exceptions: 1) when |
| | | Available Admission Capacity |
| | | Bitmask equals 0 (Available |
| | | Admission Capacity List contains |
| | | no entries), or 2) when the BSS |
| | | Load element is present and the |
| | | Available Capacity Bitmask |
| | | equals 256 (Available Admission |
| | | Capacity List contains only the |
| | | AC_VO entry). |
| 26 | BSS AC Access Delay | The BSS AC Access Delay |
| | | element is optionally present if |
| | | dot11RMBSSAverageAccessDelayActivated |
| | | is true and at least |
| | | one field of the element is not |
| | | equal to 255 (measurement not |
| | | available). |
| 27 | Mobility Domain | The MDE is present if |
| | | dot11FastBSSTransitionActivated |
| | | is true. |
| 28 | DSE registered location | The DSE Registered Location |
| | | element is present if |
| | | dot11LCIDSERequired is true. |
| 29 | Extended Channel Switch | The Extended Channel Switch |
| | Announcement | Announcement element is |
| | | optionally present if |
| | | dot11ExtendedChannelSwitchActivated |
| | | is true. |
| 30 | Supported Operating Classes | The Supported Operating |
| | | Classes element is present if |
| | | dot11ExtendedChannelSwitchActivated |
| | | or |
| | | dot11OperatingClassesRequired |
| | | is true. |
| | | The Supported Operating |
| | | Classes element is optionally |
| | | present if |
| | | dot11TVHTOptionImplemented |
| | | is true. |
| 31 | HT Capabilities | The HT Capabilities element is |
| | | present when |
| | | dot11HighThroughputOptionImplemented |
| | | is true and the STA is |
| | | not a STA 6G.(11ax) |
| 32 | HT Operation | The HT Operation element is |
| | | included by an AP and a mesh |
| | | STA when |
| | | dot11HighThroughputOptionImplemented |
| | | is true and the AP is not |
| | | a STA 6G.(11ax) |
| 33 | 20/40 BSS Coexistence | The 20/40 BSS Coexistence |
| | | element is optionally present |
| | | when |
| | | dot112040BSSCoexistenceManagementSupport |
| | | is true. |
| 34 | Overlapping BSS Scan | The Overlapping BSS Scan |
| | Parameters | Parameters element is optionally |
| | | present if |
| | | dot11FortyMHzOptionImplemented |
| | | is true. |
| 35 | Extended Capabilities | The Extended Capabilities |
| | | element is present if any of the |
| | | fields in this element are |
| | | nonzero. |
| 36 | QoS Traffic Capability | The QoS Traffic Capability |
| | | element is optionally present if |
| | | dot11ACStationCountActivated is |
| | | true. |
| 37 | Channel Usage | One or more(#6072) Channel |
| | | Usage elements are present if at |
| | | least one Channel Usage |
| | | element is present in the Probe |
| | | Request frame and |
| | | dot11ChannelUsageActivated is |
| | | true. |
| 38 | Time Advertisement | The Time Advertisement element |
| | | is present if |
| | | dot11UTCTSFOffsetActivated is |
| | | true. |
| 39 | Time Zone | The Time Zone element is |
| | | present if |
| | | dot11UTCTSFOffsetActivated is |
| | | true. |
| 40 | Interworking | The Interworking element is |
| | | present if |
| | | dot11InterworkingServiceActivated |
| | | is true. |
| 41 | Advertisement Protocol | Advertisement Protocol element |
| | | is present if |
| | | dot11InterworkingServiceActivated |
| | | is true and at least one |
| | | dot11GASAdvertisementID |
| | | exists. |
| 42 | Roaming Consortium | The Roaming Consortium |
| | | element is present if |
| | | dot11InterworkingServiceActivated |
| | | is true and the |
| | | dot11RoamingConsortiumTable |
| | | has at least one entry. |
| 43 | Emergency Alert Identifier | One or more Emergency Alert |
| | | Identifier elements are present if |
| | | dot11EASActivated is true and |
| | | there are one or more EAS |
| | | message(s) active in the |
| | | network. |
| 44 | Mesh ID | The Mesh ID element is present |
| | | if dot11MeshActivated is true. |
| 45 | Mesh Configuration | The Mesh Configuration element |
| | | is present if dot11MeshActivated |
| | | is true. |
| 46 | Mesh Awake Window | The Mesh Awake Window |
| | | element is optionally present if |
| | | dot11MeshActivated is true. |
| 47 | Beacon Timing | The Beacon Timing element is |
| | | optionally present if both |
| | | dot11MeshActivated and |
| | | dot11MBCAActivated are true. |
| 48 | MCCAOP Advertisement | The MCCAOP Advertisement |
| | Overview | Overview element is optionally |
| | | present if both |
| | | dot11MeshActivated and |
| | | dot11MCCAActivated are true. |
| 49 | MCCAOP Advertisement | One or more MCCAOP |
| | | Advertisement elements are |
| | | optionally present if both |
| | | dot11MeshActivated and |
| | | dot11MCCAActivated are true. |
| 50 | Mesh Channel Switch | The Mesh Channel Switch |
| | Parameters | Parameters element is present if |
| | | dot11MeshActivated is true and |
| | | either Channel Switch |
| | | Announcement element or |
| | | Extended Channel Switch |
| | | Announcement element is |
| | | present. |
| 51 | QMF Policy | The QMF Policy element is |
| | | present if dot11QMFActivated is |
| | | true and the QMFActivated |
| | | subfield is 1 in the Extended |
| | | Capabilities element in the Probe |
| | | Request that elicited this Probe |
| | | Response frame. |
| 52 | QLoad Report | The QLoad Report element is |
| | | present if |
| | | dot11QLoadReportActivated is |
| | | true. |
| 53 | Multi-band | The Multi-band element is |
| | | optionally present if |
| | | dot11MultibandImplemented is |
| | | true. |
| 54 | DMG Capabilities | The DMG Capabilities element is |
| | | present if |
| | | dot11DMGOptionImplemented is |
| | | true. |
| 55 | DMG Operation | The DMG Operation element is |
| | | present if |
| | | dot11DMGOptionImplemented is |
| | | true. |
| 56 | Multiple MAC Sublayers | The Multiple MAC Sublayers |
| | | element is present if |
| | | dot11MultipleMACActivated is |
| | | true. |
| 57 | Antenna Sector ID Pattern | The Antenna Sector ID Pattern |
| | | element is optionally present if |
| | | dot11DMGOptionImplemented is |
| | | true. |
| 58 | VHT Capabilities | The VHT Capabilities element is |
| | | present when |
| | | dot11VHTOptionImplemented is |
| | | true and the STA is not a STA |
| | | 6G.(11ax) |
| 59 | VHT Operation | The VHT Operation element is |
| | | present when |
| | | dot11VHTOptionImplemented is |
| | | true and the STA is not a STA |
| | | 6G and is optionally present if |
| | | dot11HEOptionImplemented is |
| | | true; otherwise, it is not |
| | | present.(11ax) |
| 60 | Transmit Power Envelope | (11ax)One Transmit Power |
| | element | Envelope element is present for |
| | | each distinct |
| | | combination of values of the |
| | | Maximum Transmit Power |
| | | Interpretation subfield and |
| | | Maximum Transmit Power |
| | | Category subfield that is |
| | | supported for the BSS if both of |
| | | the following conditions are met: |
| | | Either |
| | | dot11VHTOptionImplemented or |
| | | dot11ExtendedSpectrumManagementImplemented |
| | | is true. |
| | | Either dot11SpectrumManagementRequired |
| | | is true or |
| | | dot11RadioMeasurementActivated is true. |
| | | Otherwise, this element is not |
| | | present. |
| | | NOTE-In a 6 GHz HE AP, both |
| | | dot11VHTOptionImplemented |
| | | (see 26.17.1 (Basic HE BSS |
| | | operation)) and |
| | | dot11SpectrumManagementRequired |
| | | (see 26.17.2.1 (General)) are true. |
| 61 | Channel Switch Wrapper | The Channel Switch Wrapper |
| | element | element is optionally present if |
| | | dot11VHTOptionImplemented or |
| | | dot11ExtendedSpectrumManagementImplemented |
| | | is true and at |
| | | least one of a Channel Switch |
| | | Announcement element or an |
| | | Extended Channel Switch |
| | | Announcement element is also |
| | | present in the Probe Response |
| | | frame and the Channel Switch |
| | | Wrapper element contains at |
| | | least one subelement. |
| | | The Channel Switch Wrapper |
| | | element is optionally present if |
| | | dot11S1GOptionImplemented is |
| | | true and Extended Channel |
| | | Switch Announcement element is |
| | | present in the Probe Response |
| | | frame. |
| 62 | Extended BSS Load element | The Extended BSS Load |
| | | element is optionally present if |
| | | dot11QBSSLoadImplemented and |
| | | dot11VHTOptionImplemented |
| | | are both true.(#6311) |
| 63 | Quiet Channel | Either one Quiet Channel |
| | | element containing an AP Quiet |
| | | Mode field equal to 0 or, in an |
| | | infrastructure BSS, one or more |
| | | Quiet Channel elements each |
| | | containing an AP Quiet Mode |
| | | field equal to 1 are optionally |
| | | present if |
| | | dot11VHTOptionImplemented is |
| | | true, and either |
| | | dot11SpectrumManagementRequired or |
| | | dot11RadioMeasurementActivated is true. |
| 64 | Operating Mode Notification | The Operating Mode Notification |
| | | element is optionally present if |
| | | dot11OperatingModeNotificationImplemented |
| | | is true. |
| 65 | Reduced Neighbor Report | (11ax)One or more Reduced |
| | | Neighbor Report elements are |
| | | optionally present if |
| | | dot11TVHTOptionImplemented, |
| | | dot11FILSActivated, or |
| | | dot11ColocatedRNRImplemented |
| | | is true; otherwise, they are not |
| | | present. |
| 66 | TVHT Operation | The TVHT Operation element is |
| | | present for a TVHT STA when |
| | | dot11TVHTOptionImplemented |
| | | is true; otherwise it is not |
| | | present. |
| 67 | Estimated Service Parameters | The Estimated Service |
| | Inbound | Parameters Inbound element is |
| | | optionally present if |
| | | dot11EstimatedServiceParametersInboundOptionImplemented |
| | | is true. |
| 68 | Relay Capabilities | The Relay Capabilities element |
| | | is present if dot11RelayActivated |
| | | is true; otherwise not present. |
| 69 | CAG Number | The CAG Number element is |
| | | optionally present if |
| | | dot11FILSActivated is true; |
| | | otherwise not present. |
| 70 | FILS Indication | The FILS Indication element is |
| | | present if dot11FILSActivated is |
| | | true; otherwise not present. |
| 71 | AP-CSN | The AP-CSN element is |
| | | optionally present if |
| | | dot11FILSActivated is true; |
| | | otherwise not present. |
| 72 | DILS | The DILS element is optionally |
| | | present if dot11FILSActivated is |
| | | true; otherwise not present. |
| 73 | RPS | The RPS element is optionally |
| | | present if |
| | | dot11RAWOperationActivated is |
| | | true; otherwise not present. |
| 74 | Page Slice | The Page Slice element is |
| | | optionally present if |
| | | dot11PageSlicingActivated is |
| | | true; otherwise not present. |
| 75 | Change Sequence | The Change Sequence element |
| | | is optionally present if |
| | | dot11S1GOptionImplemented is |
| | | true; otherwise not present. |
| 76 | TSF Timer Accuracy | The TSF Timer Accuracy |
| | | element is optionally present |
| | | when |
| | | dot11TSFTimerAccuracyImplemented |
| | | is true; otherwise not |
| | | present. |
| 77 | S1G Relay Discovery | The S1G Relay Discovery |
| | | element is optionally present if |
| | | dot11RelayDiscoveryOptionImplemented |
| | | is true; otherwise not |
| | | present. |
| 78 | S1G Capabilities | The S1G Capabilities element is |
| | | present if |
| | | dot11S1GOptionImplemented is |
| | | true; otherwise not present. |
| 79 | S1G Operation | The S1G Operation element is |
| | | present when |
| | | dot11S1GOptionImplemented is |
| | | true; otherwise not present. |
| 80 | MAD | The MAD element is optionally |
| | | present if |
| | | dot11S1GOptionImplemented is |
| | | true; otherwise not present. |
| 81 | Short Beacon Interval | The Short Beacon Interval |
| | | element is present if |
| | | dot11ShortBeaconInterval is |
| | | true. |
| 82 | S1G Open-Loop Link Margin | The S1G Open-Loop Link Margin |
| | Index | Index element is optionally |
| | | present if |
| | | dot11S1GOptionImplemented is |
| | | true; otherwise not present. |
| 83 | S1G Relay | The S1G Relay element is |
| | | optionally present if |
| | | dot11RelayAPImplemented is |
| | | true; otherwise not present. |
| 84 | Max Channel Switch Time | The Max Channel Switch Time |
| | | element is optionally present |
| | | when a Channel Switch |
| | | Announcement or an Extended |
| | | Channel Switch Announcement |
| | | element is also present. |
| 85 | CDMG Capabilities | The CDMG Capabilities element |
| | | is present if |
| | | dot11CDMGOptionImplemented |
| | | is true; otherwise not present. |
| 86 | Extended Cluster Report | The Extended Cluster Report |
| | | element is optionally present if |
| | | dot11ClusteringActivated is true; |
| | | otherwise not present. |
| 87 | CMMG Capabilities | The CMMG Capabilities element |
| | | is present when |
| | | dot11CMMGOptionImplemented |
| | | is true; otherwise not present. |
| 88 | CMMG Operation | The CMMG Operation element is |
| | | present when |
| | | dot11CMMGOptionImplemented |
| | | is true; otherwise not present. |
| 89 | Estimated Services Parameters | The Estimated Service |
| | Outbound | Parameters Outbound element is |
| | | optionally present if |
| | | dot11EstimatedServiceParametersOutboundOptionImplemented |
| | | is true. |
| 90 | Service Hint | The Service Hint element is |
| | | optionally present if |
| | | dot11UnsolicitedPADActivated is |
| | | true. |
| 91 | Service Hash | The Service Hash element is |
| | | optionally present if |
| | | dot11UnsolicitedPADActivated is |
| | | true. |
| 92(11ax) | RSN Extension | The RSNXE is present if any |
| | | subfield of the Extended RSN |
| | | Capabilities field in this element |
| | | is nonzero, except the Field |
| | | Length subfield. |
| 93(11ax) | Multiple BSSID Configuration | The Multiple BSSID |
| | | Configuration element is |
| | | optionally present if |
| | | dot11MultiBSSIDImplemented is |
| | | true. |
| 94(11ax) | HE Capabilities | The HE Capabilities element is |
| | | present if |
| | | dot11HEOptionImplemented is |
| | | true; otherwise, it is not present. |
| 95(11ax) | HE Operation | The HE Operation element is |
| | | present if |
| | | dot11HEOptionImplemented is |
| | | true; otherwise, it is not present. |
| 96(11ax) | TWT | The TWT element is optionally |
| | | present within broadcast Probe |
| | | Response frames if |
| | | dot11TWTOptionActivated, |
| | | dot11HEOptionImplemented and |
| | | dot11FILSOmitReplicateProbeResponses |
| | | are true; otherwise, it |
| | | is not present. If the TWT |
| | | element is present, then the |
| | | Negotiation Type subfield of the |
| | | TWT element is 2. |
| 97(11ax) | UORA Parameter Set | The UORA Parameter Set |
| | | element is optionally present if |
| | | dot11OFDMARandomAccessOptionImplemented |
| | | is true; |
| | | otherwise, it is not present. |
| 98(11ax) | BSS Color Change | The BSS Color Change |
| | Announcement | Announcement element is |
| | | optionally present if |
| | | dot11HEOptionImplemented is |
| | | true; otherwise, it is not present. |
| 99(11ax) | Spatial Reuse Parameter Set | The Spatial Reuse Parameter |
| | | Set element is optionally present |
| | | if dot11HEOptionImplemented is |
| | | true; otherwise, it is not present. |
| 100(11ax) | MU EDCA Parameter Set | The MU EDCA Parameter Set |
| | | element is present if |
| | | dot11HEOptionImplemented is |
| | | true and |
| | | dot11MUEDCAParametersActivated |
| | | is true; otherwise, it is not |
| | | present. |
| 101(11ax) | ESS Report | The ESS Report element is |
| | | optionally present. |
| 102(11ax) | NDP Feedback Report | The NDP Feedback Report |
| | Parameter Set | Parameter Set element is |
| | | optionally present if |
| | | dot11HEOptionImplemented is |
| | | true; otherwise, it is not present. |
| 103(11ax) | HE BSS Load | The HE BSS Load element is |
| | | optionally present if |
| | | dot11QBSSLoadImplemented |
| | | and dot11HEOptionImplemented |
| | | are true. |
| 104(11ax) | HE 6 GHz Band Capabilities | The HE 6 GHz Band Capabilities |
| | | element is present if |
| | | dot11HEOptionImplemented and |
| | | dot11HE6GOptionImplemented |
| | | are true. |
| 105(11ax) | TWT Constraint Parameters | The TWT Constraint Parameters |
| | | element is optionally present if |
| | | dot11TWTOptionActivated is |
| | | true; otherwise, it is not present. |
| 106(11ay) | EDMG Capabilities | The EDMG Capabilities element |
| | | is present if |
| | | dot11EDMGOptionImplemented |
| | | is true. |
| 107(11ay) | EDMG Operation | The EDMG Operation element is |
| | | present if |
| | | dot11EDMGOptionImplemented |
| | | is true. |
| 108(11ay) | Unsolicited Block Ack Extension | The Unsolicited Block Ack |
| | | Extension element is optionally |
| | | present if |
| | | dot11UnsolicitedBAActivated is |
| | | true and is absent otherwise. |
| 109(11ba) | WUR Capabilities | The WUR Capabilities element is |
| | | present when |
| | | dot11WUROptionImplemented is |
| | | true; otherwise it is not present. |
| 110(11ba) | WUR Operation | The WUR Operation element is |
| | | present when |
| | | dot11WUROptionImplemented is |
| | | true; otherwise it is not present. |
| 111(11ba) | WUR Discovery | The WUR Discovery element is |
| | | optionally present |
| | | if dot11WUROptionImplemented |
| | | is true and either |
| | | dot11WURDiscoveryImplemented or |
| | | dot11WURNeighborDiscoveryImplemented |
| | | is true; otherwise it is |
| | | not present. |
| 112(#6050) | Authentication Control | The Authentication Control |
| | | element is optionally present |
| | | when |
| | | dot11S1GCentralizedAuthenticationControlActivated |
| | | is true or |
| | | dot11S1GDistributedAuthenticationControlActivated |
| | | is true; |
| | | otherwise it is not present. |
| 113(11bc) | EBCS Parameters | This element is present if |
| | | dot11EBCSSupportActivated is |
| | | true and the length of |
| | | dot11EBCSTrafficStreamTable is |
| | | larger than 0, otherwise not |
| | | present. |
| 114 (This is an | EDP List | The EDP List element is present |
| example of numbering; | | if the |
| exact number will be | | dot11EDPGroupEpochActivated |
| provided by IANA | | is true; otherwise, it is not |
| in the future) | | present. This element |
| | | carries a list of EDP Epoch |
| | | Settings fields including the |
| | | parameters of the different EDP |
| | | epochs available in the BSS. |
| 115 (This is an | EDP | The EDP element (see 9.4.2.348 - |
| example of numbering; | | EDP element) is present if the |
| exact number will be | | dot11EDPGroupEpochActivated |
| provided by IANA | | is true; otherwise, it is not |
| in the future) | | present. This element carries the |
| | | parameters of an EDP epoch |
| | | available in the BSS. |
| Last-1 | Vendor Specific | One or more Vendor Specific |
| | | elements are optionally present. |
| | | These elements follow all other |
| | | elements, except the Requested |
| | | elements. |
| Last | Requested elements | Elements requested by the |
| | | Request element or Extended |
| | | Request element(s) of the Probe |
| | | Request frame are present if |
| | | dot11MultiDomainCapabilityActivated or |
| | | dot11EstimatedServiceParametersInboundOptionImplemented |
| | | is true. See 11.1.4.3.2 (Active |
| | | scanning procedure for a non- |
| | | DMG STA) and 11.44 (Estimated |
| | | throughput). |

In some examples, and/or considering the flexibility of the EDP epoch settings field, the EDP list element (as discussed above) and/or the EDP element, carried in a probe response frame may include EDP Epoch Settings fields with all possible information of the EDP epoch (e.g., full set of EDP epoch parameters), partial information, and/or may include a reduced version of it. For example, the reduced version of the EDP epoch settings fields may include an EDP epoch settings control, an EDP group ID, and/or an epoch interval. For example, each different EDP epoch settings field included in the EDP list element or EDP element may or may not include all the fields or a combination of them.

In some examples, different EDP Epoch settings fields within an EDP List element may have a different structure and/or contain different subfields. In a different implementation, an AP may include in its probe response frames an EDP element, for example, to only advertise the default EDP group. A different implementation may signal the different parameters for the epoch groups using any of the information defined in the EDP element but as a separated element and/or subfield (e.g., not element). For example, one implementation may include only the group ID and the Epoch interval in its probe response frames.

In some examples, probe request and/or response frames may be used for discovering available networks (e.g., active scanning), which may be the first step toward authentication and/or association with an access point. For example, probe response frames may be replies from access points to clients actively looking for Wi-Fi networks, providing the information needed to decide whether and/or how to connect. With respect to including EDP parameters in probe response frames, as described herein, a STA may be able to understand the different EDP groups available in the AP and/or BSS. This information may be used later during the association process to indicate to the AP the group the STA desires to join.

Modification of the EDP group parameter frame format may be implemented. In some examples, an EDP Group Parameter frame format may be shown in Table 3 (e.g., Table 9-658z—EDP Group Parameter frame Action field format).

TABLE 3a
(Table 9-658z - EDP Group Parameter frame Action field format)

| Order | Meaning |
|---|---|
| 0 | Category |
| 1 | EDP Action |
| 2 | Dialog Token |
| 3 | Number of EDP Epoch Settings Included |
| 4 | EDP Epoch Settings List |

This frame may use two non-element fields which have been included in the EDP List element (as described above). In some examples, this frame may make use of the EDP List element instead of two non-element fields.

In some examples, the EDP Group Parameter frame format may be as follows (e.g., modified version of Table 3 (Table 9-658z as described in the table above)):

TABLE 3b
(Table 9-658z - EDP Group Parameter frame Action field format)

| Order | Meaning |
|---|---|
| 0 | Category |
| 1 | EDP Action |
| 2 | Dialog Token |
| 3 | EDP List |

The category field may be defined in the standards (e.g., Action field). The EDP action field may be defined in standards (e.g., EDP Action field). The EDP list element is defined as discussed above (e.g., EDP List element).

Inclusion of EDP epoch parameters in neighbor report element may be implemented. In some examples, the neighbor report element is used to describe a neighboring AP, assisting a STA during roaming and/or network selection procedures.

In some examples, modifications to the element, to include the information on the available EDP epochs, may be implemented. Changes may include, for example, a change in the BSSID information field (e.g., add a bit to indicate the EDP capabilities of the reported AP). Changes may include, for example, adding two sub-elements to the optional sub-elements field, including an EDP list sub-element and an EDP sub-element. This information may be sent by an AP and received by STAs, which may use this information to select APs (e.g., for roaming purposes). In some examples, when APs include EDP group information in their neighbor report element, STAs may be able to take decisions on selecting a target AP for roaming purposes which advertise group EDP parameters meeting the privacy requirements of the STA.

In some examples, the neighbor report element describes an AP. The format of the neighbor report element may be shown in FIG. 5 (e.g., 9-416—Neighbor Report element format). As shown in FIG. 5, the Neighbor Report element format 500 may include element ID 502, length 504, BSSID 506, BSSIS information 508, operating class 510, channel number 512, PHY type 514 and/or optional sub-elements 516. For example, the element ID and length fields are defined in the standards (e.g. general). The value of the BSSID field may be the BSSID of the BSS being reported. The subsequent fields in the Neighbor Report element pertain to this BSS.

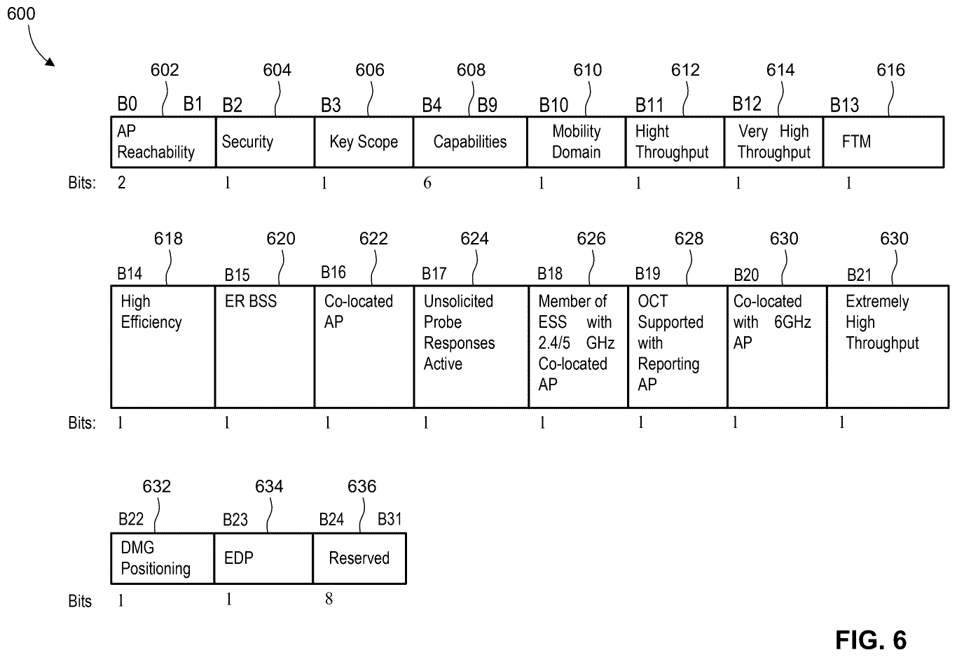

In some examples, the BSSID information field may be used to help determine neighbor service set transition candidates. For example, the format of the BSSID Information field may be shown in FIG. 6 (e.g., 9-417—BSSID Information field format). As shown in FIG. 6, the BSSID Information field format 600 may include AP reachability 602, security 604, key scope 606, capabilities 608, mobility domain 610, high throughput 612, very high throughput 614, FTM 616, high efficiency 618, ER BSS 620, co-located AP 622, unsolicited probe responses active 624, member of ESS with 2.5/5 GHz co-located AP 626, OCT supported with reporting AP 628, co-located with 6 GHz AP 630, extremely high throughput 630, DMG positioning 632, EDP 634, and/or reserved 636. The EDP field may be set to 1 to indicate the AP reported by the Neighbor Report element is an EDP AP.

The optional sub-elements field may contain zero or more sub-elements. The sub-element format and/or ordering of sub-elements are defined in the standards (e.g., sub-elements). The sub-element ID field values for the defined sub-elements are shown in Table 4 (e.g., Table 9-212 (Optional sub-element IDs for Neighbor Report)).

TABLE 4
(Table 9-212-Optional subelement IDs for Neighbor Report)

| Subelement ID | Name | Extensible |
|---|---|---|
| 0 | Reserved | |
| 1 | TSF Information | Yes |
| 2 | Condensed Country String | Yes |
| 3 | BSS Transition Candidate | No |
| | Preference | |
| 4 | BSS Termination Duration | No |
| 5 | Bearing | No |
| 6 | Wide Bandwidth Channel | Yes |
| 7-38 | Reserved | |
| 39 | Measurement Report | Subelements |
| 40-44 | Reserved | |
| 45 | HT Capabilities subelement | Yes |
| 46-60 | Reserved | |
| 61 | HT Operation subelement | Yes |
| 62 | Secondary Channel Offset | No |
| | subelement | |
| 63-65 | Reserved | |
| 66 | Measurement Pilot Transmission | Subelements |
| 67-69 | Reserved | |
| 70 | RM Enabled Capabilities | Yes |
| 71 | Multiple BSSID | Subelements |
| 72-190 | Reserved | |
| 191 | VHT Capabilities | Yes |
| 192 | VHT Operation | Yes |
| 193(11ax) | HE Capabilities | Yes |
| 194(11ax) | HE Operation | Yes |
| 195(11ax) | BSS Load | |
| 196(11ax) | HE BSS Load | Yes |
| 197(11ax) | SSID | |
| 198(#3005) | HE 6 GHz Band Capabilities | Yes |
| 199 (This is an | EDP List | Yes |
| example of numbering; | | |
| exact number will be | | |
| provided by IANA | | |
| in the future) | | |
| 200 (This is an | EDP | Yes |
| example of numbering; | | |
| exact number will be | | |
| provided by IANA | | |
| in the future) | | |
| 201-220 | Reserved | |
| 221 | Vendor Specific | Vendor defined |
| 222-255 | Reserved | |

In some examples, the EDP list sub-element includes a list of the EDP epoch parameters supported by the reported AP. This element is defined as discussed above (e.g., EDP list element). The EDP sub-element may include the EDP epoch parameters of an EDP epoch supported by the reported AP. This element is defined in the standards (e.g., EDP element). In some examples, a different implementation may signal the different parameters for the epoch groups using any of the information defined in the EDP element but as a separated element and/or subfield (e.g., not an element). For example, one implementation may include only the group ID and/or the epoch interval in the neighbor report. One implementation may include only the epoch interval assuming only the default group is advertised.

EDP epoch parameters may be included in reduced neighbor report (RNR) element. In some examples, the RNR may be modified to include information on the group EDP epochs available in the reported AP to enable a STA to select an AP based on available EDP epochs. The RNR may be expressed in multiple ways. For example, the RNR may include the information on the default group EDP epoch. The RNR may include the information on any other group EDP epoch in use by the AP.

The RNR may be used by an AP to guide a STA in network selection. The RNR may provide the minimum information needed to identify target AP. In some examples, the RNR may include information on the default group EDP Epoch parameters so that an STA may understand the default group EDP parameters before association. In some examples, the information on the default group EDP Epoch parameters may be used later during association to request the desired EDP group to the AP.

In some examples, the EDP element may be used considering minimum length for the default group EDP epoch. For example, the EDP element may have a minimum length of 5 octets, including the EDP Epoch Settings Control field, the Group ID field, and the Epoch Interval.

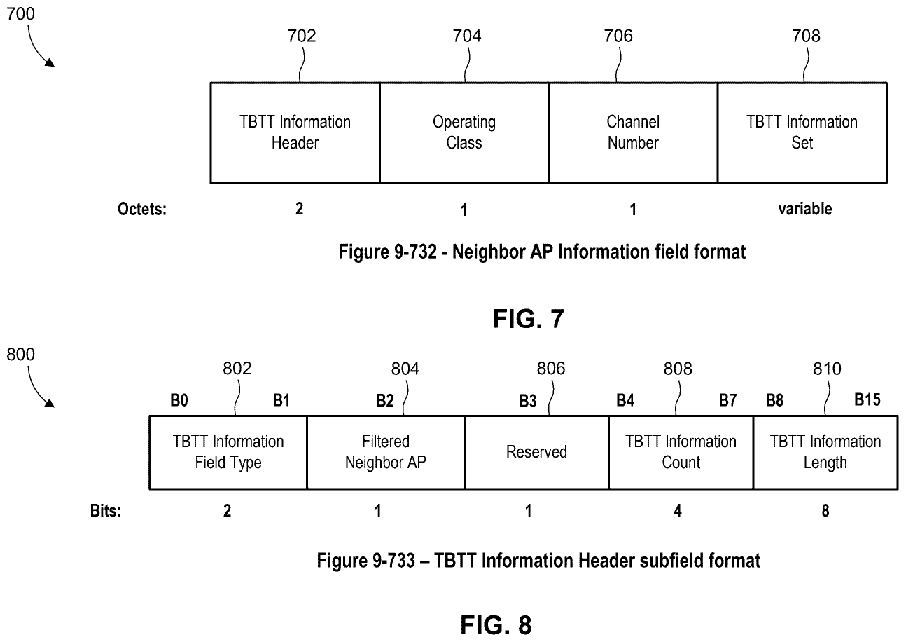

FIG. 7 is a table including an example of a neighbor AP information field 700 format (e.g., 9-732—neighbor AP information field format). As shown in FIG. 7, the neighbor AP information field 700 may include TBTT information header 702, operating class 704, channel number 706 and/or TBTT information set 708. The neighbor AP field may specify a target beacon transmission time. (TBTT) and other information related to a group of neighbor APs on one channel.

FIG. 8 is a table including an example of a TBTT information header subfield format 1200 (e.g., 9-733—TBTT information header subfield format). As shown in FIG. 8, the TBTT information header subfield format 800 may include TBTT Information Field Type 802, filtered neighbor AP 804, reserved 806, TBTT information count 808, and/or TBTT information length 810.

In some examples, the TBTT Information field type subfield may identify, together with the TBTT Information length subfield, the format of the TBTT information field. The TBTT Information field type subfield may be set to 0 or 1, wherein values 2 and/or 3 may be reserved. The filtered neighbor AP subfield may be reserved except when the RNR element is carried in a probe response frame transmitted by a Television Very High Throughput (TVHT) AP. In some examples, in a probe response frame transmitted by a TVHT AP, the filtered neighbor AP subfield may be set to 1 if the specific SSID corresponding to every BSS of the APs in this neighbor AP information field matches the SSID in the corresponding probe request frame. Otherwise, the filtered neighbor AP subfield may be set to 0.

In some examples, the TBTT information count subfield may contain the number of TBTT Information fields included in the TBTT information set field of the neighbor AP information field, minus one. The TBTT information length subfield may indicate the length of each TBTT information field included in the TBTT information set field of the neighbor AP information field.

In some examples, the TBTT information length subfield, when the TBTT Information field type subfield is equal to 0, may be interpreted as shown in Table 5 (e.g., 9-328—TBTT Information field contents when TBTT information field type equal to 0).

TABLE 5
(e.g., 9-328 - TBTT Information field contents
when TBTT information field type equal to 0).

| TBTT Information | |
|---|---|
| Length subfield | |
| value | TBTT Information field contents |
| 0 | Reserved |
| 1 | The Neighbor AP TBTT Offset subfield |
| 2 | The Neighbor AP TBTT Offset subfield and the |
| | BSS Parameters subfield |
| 3 | Reserved |
| 4 | Reserved |
| 5 | The Neighbor AP TBTT Offset subfield and the |
| | Short SSID subfield |
| 6 | The Neighbor AP TBTT Offset subfield, the Short |
| | SSID subfield, and the BSS Parameters subfield |
| 7 | The Neighbor AP TBTT Offset subfield and the |
| | BSSID subfield |
| 8 | The Neighbor AP TBTT Offset subfield, the BSSID |
| | subfield, and the BSS Parameters subfield |
| 9 | The Neighbor AP TBTT Offset subfield, the BSSID |
| | subfield, the BSS Parameters subfield, and the 20 |
| | MHz PSD subfield |
| 10 | Reserved |
| 11 | The Neighbor AP TBTT Offset subfield, the BSSID |
| | subfield and the Short SSID subfield |
| 12 | The Neighbor AP TBTT Offset subfield, the BSSID |
| | subfield, the Short SSID subfield, and the BSS |
| | Parameters subfield |
| 13 | The Neighbor AP TBTT Offset subfield, the BSSID |
| | subfield, the Short SSID subfield, the BSS |
| | Parameters subfield, and the 20 MHz PSD subfield |
| 14 | Reserved |
| 15 | Reserved |
| 16 | The Neighbor AP TBTT Offset subfield, the BSSID |
| | subfield, the Short-SSID subfield, the BSS |
| | Parameters subfield, the 20 MHz PSD subfield and |
| | the MLD Parameters subfield |
| 17 | Reserved |
| 18 | Reserved |
| 19 | Reserved |
| 20 | Reserved |
| 21 | The Neighbor AP TBTT Offset subfield, the BSSID |
| | subfield, the Short-SSID subfield, the BSS |
| | Parameters subfield, the 20 MHz PSD subfield, the |
| | MLD Parameters subfield and the EDP element. |
| 22-255 | The first 21 octets of the field contain the Neighbor |
| | AP TBTT Offset subfield, the BSSID subfield, the |
| | Short-SSID subfield the BSS Parameters subfield, |
| | and the 20 MHz PSD subfield, the MLD |
| | Parameters subfield and the EDP element (i.e., |
| | same contents as when the length of the TBTT |
| | Information field is 21). The remaining octets are |
| | reserved |

The TBTT information length subfield, when the TBTT information field type subfield is equal to 1, may be interpreted as shown in Table 6 (e.g., 9-330—TBTT Information field contents when TBTT information field type subfield equal to 1).

TABLE 6
(e.g., 9-330 - TBTT Information field contents when
TBTT information field type subfield equal to 1).

| TBTT Information | |
|---|---|
| Length subfield | |
| value | TBTT Information field contents |
| 0-1 | Reserved |
| 2 | The EBCS Info Frame Tx Countdown field as |
| | defined in 9.4.1.70 (EBCS Info Frame Tx |
| | Countdown field) |
| 3 | MLD Parameters |
| 4-7 | Reserved |
| 8 | MLD Parameters and the EDP element. |
| 9-255 | Reserved |

In some examples, the TBTT information set field may contain one or more TBTT information fields. For example, the TBTT information set field may contain the TBTT Information field if the TBTT Information Field Type subfield is equal to 0, and may be defined in FIG. 9 (e.g., 9-734—TBTT Information field format if the TBTT Information Field Type subfield is equal to 0). FIG. 9 is an example for TBTT Information field format if the TBTT Information Field Type sub-field is equal to 0. As shown in FIG. 9, the TBTT Information field format if the TBTT Information Field Type sub-field is equal to 0 900 may include Neighbor AP TBTT offset 902, basic service set identifier (BSSID) 904, short service set identifier (SSID) 906, BSS parameters 908, 20 MHz power spectral density (PSD) 910, multi-link device (MLD) parameters 912 and/or EDP parameters 914.

If the TBTT information field type subfield is set to 1, the TBTT information field may carry the MLD parameters subfield and/or the EDP element, as shown in FIG. 10 (e.g., 9-734b—TBTT Information field format). FIG. 10 is an example for TBTT Information field format when the TBTT Information Field Type sub-field is equal to 1. As shown in FIG. 10, the TBTT Information field format when the TBTT Information Field Type sub-field is equal to 1 1000 may include enhanced broadcast services (EBCS) info frame Tx countdown field 1002, multi-link device (MLD) parameters 1004 and/or EDP parameters 1006.

The EDP parameters subfield may be defined in the standards (e.g., EDP element). In the RNR, the EDP element may only consist of the first 5 octets of the element (e.g., the EDP Epoch Settings Control field, the Group ID field, and/or the Epoch Interval).

In some examples, the RNR may be limited to group ID and epoch Interval may be used for the RNR. For example, the reduced EDP Parameters field may be included in the RNR. The reduced EDP parameters field may have a minimum length of 3 octets, including the group ID field and the epoch Interval information.

In some examples, the neighbor AP information field may specify the TBTT and/or other information related to a group of neighbor APs on one channel. For example, FIG. 11 is a table including an example of a neighbor AP information field 1100 format (e.g., 9-732—neighbor AP information field format). As shown in FIG. 11, the neighbor AP information field 1100 may include TBTT information header 1102, operating class 1104, channel number 1106 and/or TBTT information set 1108.

The format of the TBTT information header subfield may be defined in FIG. 12. FIG. 12 is a table including an example of a TBTT information header subfield format 1200 (e.g., 9-733—TBTT information header subfield format). As shown in FIG. 12, the TBTT information header subfield format 1200 may include TBTT Information Field Type 1202, filtered neighbor AP 1204, reserved 1206, TBTT information count 1208, and/or TBTT information length 1210.

In some examples, the TBTT Information field type subfield may identify, together with the TBTT Information length subfield, the format of the TBTT information field. The TBTT Information field type subfield may be set to 0 or 1, wherein values 2 and/or 3 may be reserved. The filtered neighbor AP subfield may be reserved except when the RNR element is carried in a probe response frame transmitted by a Television Very High Throughput (TVHT) AP. In some examples, in a probe response frame transmitted by a TVHT AP, the filtered neighbor AP subfield may be set to 1 if the specific SSID corresponding to every BSS of the APs in this neighbor AP information field matches the SSID in the corresponding probe request frame. Otherwise, the filtered neighbor AP subfield may be set to 0.

In some examples, the TBTT information count subfield may contain the number of TBTT information fields included in the TBTT information set field of the neighbor AP information field, minus one. The TBTT information length subfield may indicate the length of each TBTT information field included in the TBTT information set field of the neighbor AP information field.

In some examples, the TBTT information length subfield, when the TBTT Information field type subfield is equal to 0, may be interpreted as shown in Table 7 (e.g., 9-328—TBTT Information field contents when TBTT information field type equal to 0).

TABLE 7
(e.g., 9-328 - TBTT Information field contents
when TBTT information field type equal to 0).

| TBTT Information | |
|---|---|
| Length subfield | |
| value | TBTT Information field contents |
| 0 | Reserved |
| 1 | The Neighbor AP TBTT Offset subfield |
| 2 | The Neighbor AP TBTT Offset subfield and the |
| | BSS Parameters subfield |
| 3 | Reserved |
| 4 | Reserved |
| 5 | The Neighbor AP TBTT Offset subfield and the |
| | Short SSID subfield |
| 6 | The Neighbor AP TBTT Offset subfield, the Short |
| | SSID subfield, and the BSS Parameters subfield |
| 7 | The Neighbor AP TBTT Offset subfield and the |
| | BSSID subfield |
| 8 | The Neighbor AP TBTT Offset subfield, the BSSID |
| | subfield, and the BSS Parameters subfield |
| 9 | The Neighbor AP TBTT Offset subfield, the BSSID |
| | subfield, the BSS Parameters subfield, and the 20 |
| | MHz PSD subfield |
| 10 | Reserved |
| 11 | The Neighbor AP TBTT Offset subfield, the BSSID |
| | subfield and the Short SSID subfield |
| 12 | The Neighbor AP TBTT Offset subfield, the BSSID |
| | subfield, the Short SSID subfield, and the BSS |
| | Parameters subfield |
| 13 | The Neighbor AP TBTT Offset subfield, the BSSID |
| | subfield, the Short SSID subfield, the BSS |
| | Parameters subfield, and the 20 MHz PSD subfield |
| 14 | Reserved |
| 15 | Reserved |
| 16 | The Neighbor AP TBTT Offset subfield, the BSSID |
| | subfield, the Short-SSID subfield, the BSS |
| | Parameters subfield, the 20 MHz PSD subfield and |
| | the MLD Parameters subfield |
| 17 | Reserved |
| 18 | Reserved |
| 19 | The Neighbor AP TBTT Offset subfield, the BSSID |
| | subfield, the Short-SSID subfield, the BSS |
| | Parameters subfield, the 20 MHz PSD subfield, the |
| | MLD Parameters subfield and the Reduced EDP |
| | Parameters. |
| 20-255 | The first 19 octets of the field contain the Neighbor |
| | AP TBTT Offset subfield, the BSSID subfield, the |
| | Short-SSID subfield the BSS Parameters subfield, |
| | and the 20 MHz PSD subfield, the MLD |
| | Parameters subfield and the Reduced EDP |
| | Parameters (i.e., same contents as when the |
| | length of the TBTT Information field is 19). The |
| | remaining octets are reserved |

The TBTT information length subfield, when the TBTT information field type subfield is equal to 1, may be interpreted as shown in Table 8 (e.g., 9-330—TBTT Information field contents when TBTT information field type subfield equal to 1).

TABLE 8
(e.g., 9-330 - TBTT Information field contents when
TBTT information field type subfield equal to 1).

| TBTT Information | |
|---|---|
| Length subfield | |
| value | TBTT Information field contents |
| 0-1 | Reserved |
| 2 | The EBCS Info Frame Tx Countdown field as |
| | defined in 9.4.1.70 (EBCS Info Frame Tx |
| | Countdown field) |
| 3 | MLD Parameters |
| 4-5 | Reserved |
| 6 | MLD Parameters and the Reduced EDP |
| | Parameters. |
| 7-255 | Reserved |

In some examples, the TBTT information set field may include one or more TBTT information fields. For example, the TBTT information set field may include the TBTT Information field if the TBTT Information Field Type subfield is equal to 0, and may be defined in FIG. 13 (e.g., 9-734—TBTT Information field format if the TBTT Information Field Type subfield is equal to 0). FIG. 13 is an example for TBTT Information field format if the TBTT Information Field Type sub-field is equal to 0. As shown in FIG. 13, the TBTT Information field format if the TBTT Information Field Type sub-field is equal to 0 1300 may include Neighbor AP TBTT offset 1302, basic service set identifier (BSSID) 1304, short service set identifier (SSID) 1306, BSS parameters 1308, 20 MHz power spectral density (PSD) 1310, multi-link device (MLD) parameters 1312 and/or reduced EDP parameters 1314.

If the TBTT information field type subfield is set to 1, the TBTT information field may carry the MLD parameters subfield and/or the EDP element, as shown in FIG. 14 (e.g., 9-734b—TBTT Information field format). FIG. 14 is an example for TBTT Information field format when the TBTT Information Field Type sub-field is equal to 1. As shown in FIG. 14, the TBTT Information field format when the TBTT Information Field Type sub-field is equal to 1 1400 may include enhanced broadcast services (EBCS) info frame Tx countdown field 1402, multi-link device (MLD) parameters 1404 and/or reduced EDP parameters 1406.

The reduced EDP parameters format may be shown in FIG. 15 (e.g., FIG. 9-XXX—reduced EDP parameter field). The reduced EDP parameters field may be composed of the group ID and epoch interval fields, as defined in the standards (e.g., EDP epoch settings field).

FIG. 15 is a table including an example of a reduced EDP parameter field. As shown in FIG. 15, the reduced EDP parameter field 1500 may include group ID 1502 and/or epoch interval 1504.

In some examples, only the epoch interval is used for the RNR. For example, only the epoch interval may be included in the RNR. The epoch interval field may have a minimum length of 2 octets. The group ID advertised may be assumed to be 0 and/or any other value representing the default group, corresponding to the default EDP group.

In some examples, the neighbor AP information field may specify the TBTT and/or other information related to a group of neighbor APs on one channel. For example, FIG. 16 is a table including an example of a neighbor AP information field 1600 format (e.g., 9-732—neighbor AP information field format). As shown in FIG. 16, the neighbor AP information field 1600 may include TBTT information header 1602, operating class 1604, channel number 1606, and/or TBTT information set 1608.

The format of the TBTT information header subfield may be defined in FIG. 17. FIG. 17 is a table including an example of a TBTT information header subfield format 1700 (e.g., 9-733—TBTT information header subfield format). As shown in FIG. 17, the TBTT information header subfield format 1700 may include TBTT Information Field Type 1702, filtered neighbor AP 1704, reserved 1706, TBTT information count 1708, and/or TBTT information length 1710.

In some examples, the TBTT Information field type subfield may identify, together with the TBTT Information length subfield, the format of the TBTT information field. The TBTT Information field type subfield may be set to 0 or 1, wherein values 2 and/or 3 may be reserved. The filtered neighbor AP subfield may be reserved except when the RNR element is carried in a probe response frame transmitted by a Television Very High Throughput (TVHT) AP. In some examples, in a probe response frame transmitted by a TVHT AP, the filtered neighbor AP subfield may be set to 1 if the specific SSID corresponding to every BSS of the APs in this neighbor AP information field matches the SSID in the corresponding probe request frame. Otherwise, the filtered neighbor AP subfield may be set to 0.

In some examples, the TBTT information count subfield may contain the number of TBTT information fields included in the TBTT information set field of the neighbor AP information field, minus one. The TBTT information length subfield may indicate the length of each TBTT information field included in the TBTT information set field of the neighbor AP information field.

In some examples, the TBTT information length subfield, when the TBTT Information field type subfield is equal to 0, may be interpreted as shown in Table 9 (e.g., 9-328—TBTT Information field contents when TBTT information field type equal to 0).

TABLE 9
(e.g., 9-328 - TBTT Information field contents
when TBTT information field type equal to 0).

| TBTT Information | |
|---|---|
| Length subfield | |
| value | TBTT Information field contents |
| 0 | Reserved |
| 1 | The Neighbor AP TBTT Offset subfield |
| 2 | The Neighbor AP TBTT Offset subfield and the |
| | BSS Parameters subfield |
| 3 | Reserved |
| 4 | Reserved |
| 5 | The Neighbor AP TBTT Offset subfield and the |
| | Short SSID subfield |
| 6 | The Neighbor AP TBTT Offset subfield, the Short |
| | SSID subfield, and the BSS Parameters subfield |
| 7 | The Neighbor AP TBTT Offset subfield and the |
| | BSSID subfield |
| 8 | The Neighbor AP TBTT Offset subfield, the BSSID |
| | subfield, and the BSS Parameters subfield |
| 9 | The Neighbor AP TBTT Offset subfield, the BSSID |
| | subfield, the BSS Parameters subfield, and the 20 |
| | MHz PSD subfield |
| 10 | Reserved |
| 11 | The Neighbor AP TBTT Offset subfield, the BSSID |
| | subfield and the Short SSID subfield |
| 12 | The Neighbor AP TBTT Offset subfield, the BSSID |
| | subfield, the Short SSID subfield, and the BSS |
| | Parameters subfield |
| 13 | The Neighbor AP TBTT Offset subfield, the BSSID |
| | subfield, the Short SSID subfield, the BSS |
| | Parameters subfield, and the 20 MHz PSD subfield |
| 14 | Reserved |
| 15 | Reserved |
| 16 | The Neighbor AP TBTT Offset subfield, the BSSID |
| | subfield, the Short-SSID subfield, the BSS |
| | Parameters subfield, the 20 MHz PSD subfield and |
| | the MLD Parameters subfield |
| 17 | Reserved |
| 18 | The Neighbor AP TBTT Offset subfield, the BSSID |
| | subfield, the Short-SSID subfield, the BSS |
| | Parameters subfield, the 20 MHz PSD subfield, the |
| | MLD Parameters subfield and the Epoch Interval |
| | subfield. |
| 19-255 | The first 18 octets of the field contain the Neighbor |
| | AP TBTT Offset subfield, the BSSID subfield, the |
| | Short-SSID subfield the BSS Parameters subfield, |
| | and the 20 MHz PSD subfield, the MLD |
| | Parameters subfield and the Epoch Interval |
| | subfield (i.e., same contents as when the length of |
| | the TBTT Information field is 18). The remaining |
| | octets are reserved. |

The TBTT information length subfield, when the TBTT information field type subfield is equal to 1, may be interpreted as shown in Table 10 (e.g., 9-330—TBTT Information field contents when TBTT information field type subfield equal to 1).

TABLE 10
(e.g., 9-330 - TBTT Information field contents when
TBTT information field type subfield equal to 1).

| TBTT Information | |
|---|---|
| Length subfield | |
| value | TBTT Information field contents |
| 0-1 | Reserved |
| 2 | The EBCS Info Frame Tx Countdown field as |
| | defined in 9.4.1.70 (EBCS Info Frame Tx |
| | Countdown field) |
| 3 | MLD Parameters |
| 4-5 | Reserved |
| 6 | MLD Parameters and the Epoch Interval subfield. |
| 7-255 | Reserved |

In some examples, the TBTT information set field may contain one or more TBTT information fields. For example, the TBTT information set field may contain the TBTT Information field if the TBTT Information Field Type subfield is equal to 0, and may be defined in FIG. 18 (e.g., 9-734—TBTT Information field format if the TBTT Information Field Type subfield is equal to 0).

FIG. 18 is a table including an example of TBTT Information field format if the TBTT Information Field Type subfield is equal to 0 1800. As shown in FIG. 18, the TBTT Information field format if the TBTT Information Field Type subfield is equal to 0 1800 may include Neighbor AP TBTT offset 1802, basic service set identifier (BSSID) 1804, short service set identifier (SSID) 1806, BSS parameters 1808, 20 MHz power spectral density (PSD) 1810, multi-link device (MLD) parameters 1812 and/or epoch interval subfield 1814.

If the TBTT information field type subfield is set to 1, the TBTT information field may carry the MLD parameters subfield and/or the EDP element, as shown in FIG. 19 (e.g., 9-734b—TBTT Information field format). FIG. 19 is an example for TBTT Information field format when the TBTT Information Field Type sub-field is equal to 1. As shown in FIG. 19, the TBTT Information field format when the TBTT Information Field Type sub-field is equal to 1 1900 may include enhanced broadcast services (EBCS) info frame Tx countdown field 1902, multi-link device (MLD) parameters 1904 and/or epoch interval subfield 1906. The epoch interval field is defined in the standards (e.g., EDP epoch settings field).

What is claimed:

1. A station (STA), comprising:
a processor configured to:
receive a neighbor report element from an access point (AP), wherein the neighbor report element comprises information on group enhanced data privacy (EDP) epochs available in the AP, wherein the information on the group EDP epochs available in the AP comprises information associated with a default group EDP epoch or on other group EDP epochs in use by the AP, wherein the information on the group EDP epochs available in the AP comprises an epoch interval information, wherein the neighbor report element is configured to enable the STA to select the AP as a target AP from a plurality of APs based on the information on the available group EDP epochs; and
transmit, to the AP, an association request frame or a re-association request frame comprising a desired EDP epoch group available in the AP based on the information on the available group EDP epochs.

2. The STA of claim 1, wherein the information on the available group EDP epochs comprises a group EDP epoch ID associated with each group EDP epoch available in the AP.

3. The STA of claim 2, wherein the information on the available group EDP epochs comprises a group EDP settings field associated with each group EDP epoch available in the AP.

4. The STA of claim 3, wherein the neighbor report element further comprises a neighbor AP information field, wherein the neighbor AP information field comprises a target beacon transmission time (TBTT) information header field and a TBTT information set field, and wherein the neighbor report element is configured to enable the STA to select the AP as a target AP from a plurality of APs based on the TBTT information, and wherein the association request frame or the re-association request frame further comprises a desired EDP epoch group available in the AP based on the TBTT information.

5. The STA of claim 4, wherein the TBTT information header field comprises at least one of TBTT information field type, filtered neighbor AP, TBTT information count or TBTT information length, and wherein the TBTT information set field comprises one or more TBTT information fields.

6. The STA of claim 5, wherein upon a condition that the value of the TBTT information field type is 0, the TBTT information field comprises a reduced EDP parameter field, neighbor AP TBTT offset, basic service set identifier (BSSID), short service set identifier (SSID), BSS parameters, 20 MHz power spectral density (PSD) or multi-link device (MLD) parameters.

7. The STA of claim 5, wherein upon a condition that the value of the TBTT information field type is 1, a TBTT information field format comprises a reduced EDP parameter field and multi-link device (MLD) parameters.

8. The STA of claim 6, wherein the reduced EDP parameter field comprises a value of 0 or 3 octets.

9. The STA of claim 7, wherein the reduced EDP parameter field comprises a group ID field and an epoch interval field, and wherein the group ID field comprises a value of 1, and the epoch interval field comprises a value of 2.

10. The STA of claim 5, wherein upon a condition that the value of the TBTT information field type is 0, the TBTT information field comprises epoch interval subfield, neighbor AP TBTT offset, basic service set identifier (BSSID), short service set identifier (SSID), BSS parameters, 20 MHz power spectral density (PSD), or multi-link device (MLD) parameters.

11. The STA of claim 5, wherein upon a condition that the value of the TBTT information field type is 1, a TBTT information field format comprises an epoch interval subfield and a multi-link device (MLD) parameters.

12. The STA of claim 10, wherein the epoch interval subfield comprises a value of 0 or 2 octets.

13. A method performed by a station (STA), the method comprising:
receiving a neighbor report element from an access point (AP), wherein the neighbor report element comprises information on group enhanced data privacy (EDP) epochs available in the AP, wherein the information on the group EDP epochs available in the AP comprises information associated with a default group EDP epoch or on other group EDP epochs in use by the AP, wherein the information on the group EDP epochs available in the AP comprises an epoch interval information, wherein the neighbor report element is configured to enable the STA to select the AP as a target AP from a plurality of APs based on the information on the available group EDP epochs; and
transmitting, to the AP, an association request frame or a re-association request frame comprising a desired EDP epoch group available in the AP based on the information on the available group EDP epochs.

14. The method of claim 13, wherein the information on the available group EDP epochs comprises a group EDP epoch ID associated with each group EDP epoch available in the AP.

15. The method of claim 14, wherein the information on the available group EDP epochs comprises a group EDP settings field associated with each group EDP epoch available in the AP.

16. The method of claim 15, wherein the neighbor report element further comprises a neighbor AP information field, wherein the neighbor AP information field comprises a target beacon transmission time (TBTT) information header field and a TBTT information set field, and wherein the neighbor report element is configured to enable the STA to select the AP as a target AP from a plurality of APs based on the TBTT information, and wherein the association request frame or the re-association request frame further comprises a desired EDP epoch group available in the AP based on the TBTT information.

17. The method of claim 16, wherein the TBTT information header field comprises at least one of TBTT information field type, filtered neighbor AP, TBTT information count or TBTT information length, and wherein the TBTT information set field comprises one or more TBTT information fields.

18. The method of claim 17, wherein upon a condition that the value of the TBTT information field type is 0, the TBTT information field comprises a reduced EDP parameter field, neighbor AP TBTT offset, basic service set identifier (BSSID), short service set identifier (SSID), BSS parameters, 20 MHz power spectral density (PSD) or multi-link device (MLD) parameters.

19. The method of claim 17, wherein upon a condition that the value of the TBTT information field type is 1, a TBTT information field format comprises a reduced EDP parameter field and multi-link device (MLD) parameters.

20. The method of claim 18, wherein the reduced EDP parameter field comprises a value of 0 or 3 octets.
